(19) United States
(12) Patent Application Publication
(10) Pub. No.: US 2019/0389104 A1
(43) Pub. Date: Dec. 26, 2019

(54) Method of Making a Vehicle Interior Component Having an Integral Airbag Component

(71) Applicant: Global IP Holdings, LLC, Sterling Heights, MI (US)

(72) Inventors: Christopher A. Heikkila, Washington Township, MI (US); Darius J. Preisler, Macomb, MI (US); Steven A. Mitchell, Linden, MI (US); Jason T. Murar, Macomb, MI (US)

(73) Assignee: Global IP Holdings, LLC, Sterling Heights, MI (US)

(21) Appl. No.: 16/014,251

(22) Filed: Jun. 21, 2018

(51) Int. Cl. B29C 45/14

(52) U.S. Cl. CPC B29C 45/14196; B29C 45/14221; B29C 45/14688; B29C 45/14786; B29L 2031/3041; B29K 2623/12; B29K 2715/003; B29K 2713/00; B29C 45/14811

(57) ABSTRACT

A method of making a vehicle interior component having an integral airbag component is provided. The method includes disposing a polymeric composite sheet having inner and outer surfaces onto a first surface of a mold at a molding station and compressing the sheet between the first surface and a second surface of the mold at the molding station. The method also includes injecting a molten polymer compatible with the polymeric material of the composite sheet into the mold cavity in accordance with a predetermined set of process parameters which are high enough to integrally form at least one airbag component via polymeric interfusion at the inner surface of the composite sheet but are low enough to reduce surface defects on the outer surface of the composite sheet.

### CROSS-REFERENCE TO RELATED APPLICATIONS

This application is a continuation-in-part of U.S. patent application Ser. Nos. 14/803,444; 14/803,450; 14/803,453; and 14/803,457 all filed on Nov. 12, 2015.

### TECHNICAL FIELD

This invention relates, in general, to methods of making vehicle interior components and, in particular, to molding methods of making such components which include an integral airbag component.

### OVERVIEW

Compression molding has long been used to manufacture plastic parts or components. While widely used to manufacture thermoset plastic parts, compression molding is also used to manufacture thermoplastic parts. The raw materials for compression molding are typically placed in an open, heated, mold cavity. The mold is then closed and pressure is applied to force the materials to fill up the entire cavity. A hydraulic ram or punch is often utilized to produce sufficient force during the molding process. The heat and pressure are maintained until the plastic materials are cured.

Two types of plastic compounds frequently used in compression molding are Bulk Molding Compound (BMC) and Sheet Molding Compound (SMC).

In general, compression molding provides good surface finish and can be applied to composite thermoplastics with woven fabrics, randomly oriented fiber mat or chopped strand. Compression molding is thought to be largely limited to flat or moderately curved parts with no undercuts.

Vacuum during compression molding of thermoset parts has been used to minimize surface defects of the type known as porosity. Porosity is caused by air that is trapped between the molding compound (i.e. raw materials) and the surface of the mold cavity. The mold chamber or cavity is sealed from the surrounding atmosphere and then the chamber is evacuated before pressure is applied to the raw materials.

Many molded parts are used in the interior of vehicles. The substrate of the part is often made of plastic or preferably of a fibrous molding material.

Natural fiber composite panels utilized as a substrate have very important characteristics because of their light weight and high environmental sustainability.

As described in U.S. patent publication Nos. 2014/0342119 and 2015/0027622, the substrate of the molded part may be realized in a laminar fashion and has an essentially plane contour or a three-dimensional contour with convex and concave regions defined by the respective design, as well as, if applicable, one or more openings and recesses for trim strips and control elements such as pushbuttons, switches and rotary knobs for power windows and exterior rearview mirrors. In order to fix the molded parts in the passenger compartment or on the vehicle door and to mount handles, control elements and storage trays on the molded part, the molded part is also equipped with mounting parts that are also referred to as retainers.

The substrate typically consists of plastics or composite materials that contain plastics such as acrylonitrile-butadiene-styrene (ABS) or polypropylene (PP). Fibrous molding materials on the basis of textile fabrics of hemp, sisal, flax, kenaf and/or wood components such as wood fibers, wood dust, wood chips or paper bound with duroplastic binders are likewise used as material for the substrate. Foamed materials of polyurethane or epoxy resins that, if applicable, are reinforced with natural fibers or glass fibers may also be considered as material for the substrate.

As described in U.S. patent publication No. 2015/0027622, an interior covering part is produced which comprises a substrate or a carrier part component and a decorative film or a decorative layer. For producing the interior covering part, a substrate of fiber molding material, in particular a natural fiber molding material, and a decorative film or a decorative layer are formed in two steps, wherein these are pressed together in a first step of the two steps and in particular hot-pressed.

As starting material or semi-finished product for a substrate, which is used for producing the carrier component, a fiber molding material in the form of a plastic mat with fiber components and especially a polypropylene (PP)-bound fiber mat with natural fibers and/or plastic fibers, a polypropylene (PP)-bound fiber mat with ceramic, carbon or glass fibers is used especially. This (substrate) can be plasticisable in particular through the supply of heat. When using a polypropylene (PP)-bound fiber mat as substrate, this preferentially comprises a material component of a fiber material, which is preferentially formed of natural fibers or glass fibers as well as plastic or carbon fibers and in particular with polypropylene (PP)-fibers (binding function). Alternatively or additionally nature fiber PP (NFPP) or glass fiber PP (GFPP) can be used as fiber mat. As natural fibers, fibers of wood, kenaf, hemp, jute, flax, china grass, rattan, soya, ocra, banana, bamboo, coconut, coir, cotton, curaua, abaca, pine, pineapple, raffia palm and/or sisal can be used. Synthetic fibers can also be used. Chips of wood can also be used as starting material for the carrier material. As synthetic fibers, carbon fibers, fibers of polyester, acrylate, aramide, Twaron, Kevlar, Technora, vinylon, Cylon and/or polypropylene can be used. A combination of a plurality of types of the mentioned natural fibers or other fibers can also be used in the substrate. As part of the present invention, the term “polymers” comprises both homopolymers as well as copolymers of the mentioned polymer types

U.S. patent publication No. 2013/0052412 discloses a vehicular trim component made by concurrent compression forming and injection molding.

The side of the respective molded part or substrate that faces the vehicle interior is usually referred to as the visible side. In order to provide the visible side with an attractive appearance, the substrate is equipped with one or more decorative elements of a textile material or a plastic film. The plastic films used for this purpose are usually colored and have a relief-like embossed surface. If applicable, the decorative elements comprise a cushioning layer of a foamed plastic that faces the substrate and provides the molded part with pleasantly soft haptics. The decorative elements are usually laminated onto the substrate or bonded thereto during the manufacture of the substrate by means of thermoplastic back-injection molding.

On its edge and/or on an installation side that lies opposite of the visible side, the substrate is advantageously equipped with projections, depressions and bores. The projections, depressions and bores serve for non-positively connecting the molded part to sections of the car body such as a car door or the roof of a passenger compartment by means of retaining elements such as clips, pins and screws.

The respective mounting parts or retainers are made of plastic or a metallic material such as sheet steel and mechanically connected to the substrate by means of retaining elements such as pins, screws or clips or by means of interlacing, clawing or clamping. Retainers advantageously comprise claws and/or clips as integral components. The claws and clips are respectively provided for engaging into recesses of the substrate or for being bent around the edge of the substrate, as well as for being fixed by means of clamping, during the installation of the retainers.

Different methods that typically comprise two or more production steps are known for the manufacture of molded parts for the interior trim of vehicles.

According to one known method, a substrate is initially produced of a fibrous molding material by means of hot-pressing. Subsequently, retainers are attached to the installation side of the substrate, e.g., by means of friction welding or bonding. In a third step, one or more decorative elements are laminated onto the visible side of the substrate. In a simplified two-step variation of the method, retainers of a metallic material with integrated retaining elements, particularly with claws, are compressed together with the fibrous molding material, wherein the retaining elements penetrate into the fibrous molding material and non-positively anchor the retainers on the substrate after the fibrous molding material has cured.

According to another known method, a substrate is manufactured of a thermoplastic by means of injection molding, particularly by means of back-injection molding. One or more decorative elements are preferably arranged in a back-injection mold and back-injected with the thermally plasticized plastic. After the molten plastic has cooled and solidified, the decorative elements are non-positively bonded to the substrate. In another step, mounting parts or retainers are respectively mounted on the installation side of the substrate.

One example of a surface texture is disclosed in WO 2010/080967 A1, according to which an interior trim panel of fibrous molding material is equipped with a smooth, transparent, liquid-impermeable, scratch-resistant and UV-resistant coating of a material, preferably a thermoplastic polymer, with a melting point in the range of 60 to 170.degree. C. The coating is applied by means of hot-pressing, wherein the material of the coating partially sinks into the fibrous molding material such that the coating is non-positively connected to the fibrous molding material.

As described in U.S. Pat. No. 5,462,421 and U.S. patent publication No. 2004/0150127, current vehicle inner door panels comprise laminates of various types. In some inner door panels, a structural backing material is covered by an embossed covering, which is often vinyl. These panels are formed by bonding the covering to the backing in a mold which embosses the covering. Sometimes a filler material, such as cellulose or a foam sheet, is bonded between the backing and covering. After bonding, the periphery of these panels must be trimmed before vehicle installation. In the past, this trimming has been usually accomplished in a separate trim fixture.

The industry has developed a mold apparatus wherein the laminate is formed in a mold that also includes external trimming knives that provide a finished panel ready for vehicle installation. Such apparatus is shown in U.S. Pat. No. 4,692,108 to Cesano. All of the materials used in forming the Cesano type of laminated panel are preformed.

Another type of inner door panel in use is a laminate comprising a structural substrate of reinforced foam covered by a vinyl covering. This type of laminate is formed by placing the vinyl and reinforcing material in a mold and thereafter injecting foamable materials, which expand, set up and cure in the mold. After curing, this unfinished laminate requires further processing before it is ready for vehicle installation. It is removed from the mold and transferred to a trim fixture, where it is finally trimmed by accurately cutting the periphery with a water jet or the like.

Some problems attend this post-formation trimming operation. For example, the unfinished panel must be accurately positioned in the fixture. If it is not, the final panel will be out of dimension and unusable. Such a panel must be scrapped. Also, this post-formation trimming operation requires additional handling, equipment and labor.

In both U.S. patent publications 5,462,421 and 2004/0150127 trim blades are carried by a mold member. In 2004/0150127 a mechanism is provided to perform perimeter edge folding and perimeter trimming of a cladding layer in a single operation.

U.S. patent publications 8,833,829 and 2012/0091698 disclose polymer skin/foam bilaminate sheets. These all-olefin sheets are low cost, low weight, recyclable sheets which can be formed into vehicle interior components.

The term “facing material” refers to a material used to conceal and/or protect structural and/or functional elements from an observer. Common examples of facing materials include upholstery, carpeting, and wall coverings (including stationary and/or movable wall coverings and cubicle wall coverings). Facing materials typically provide a degree of aesthetic appearance and/or feel, but they may also provide a degree of physical protection to the elements that they conceal. In some applications, it is desirable that the facing material provide properties such as, for example, aesthetic appeal (for example, visual appearance and/or feel) and abrasion resistance. Facing materials are widely used in motor vehicle construction.

In the automotive industry, it is common practice to refer to various surfaces as being A-, B-, or C-surfaces. As used herein, the term “A-surface” refers to an outwardly-facing surface for display in the interior of a motor vehicle. This surface is a very high visibility surface of the vehicle that is most important to the observer or that is most obvious to the direct line of vision. With respect to motor vehicle interiors, examples include dashboards, door panels, instrument panels, steering wheels, head rests, upper seat portions, headliners, load floors and pillar coverings.

As described in U.S. patent publication 2014/0225296, one problem associated with one method of making a panel of sandwich-type composite structure is that during the cold-pressing in a compression mold one or both of the skins does not fully contact or achieve abutting engagement with its respective mold half or die during the molding process. Consequently, the resulting compression-molded, composite component fails to achieve the desired component shape, as defined by the opposing surfaces of upper and lower dies.

The following U.S. patent documents are related to at least one embodiment of the present invention: U.S. Pat. Nos. 5,324,384; 5,352,397; 5,370,521; 5,502,930; 5,506,029; 5,718,791; 5,746,870; 5,915,445; 6,050,630; 6,102,464; 6,196,607; 6,435,577; 6,467,801; 6,537,413; 6,655,299; 6,682,675; 6,682,676; 6,695,998; 6,748,876; 6,790,026; 6,823,803; 6,843,525; 6,890,023; 6,981,863; 7,090,274; 7,419,713; 7,909,379; 7,919,031; 8,117,972; 9,120,399; 2003/0164577; 2003/0194542; 2005/0189674; 2006/0255611; 2008/0185866; 2011/0281076; 2011/0315310; 2013/0229024; 2013/0260112; 2013/0273191; 2013/0333837; and 2016/0176363.

As described in U.S. Pat. No. 7,037,452, injection molding is one of the most important and efficient manufacturing techniques for polymeric materials, with the capability to mass produce high value added products, such as the compact disc. Injection molding can be used for molding other materials, such as thermoset plastics, ceramics and metal powders. The process in its present form was developed in the mid 1950s, when the first reciprocating screw machines became available. Material, machine and process variations are important in this complex multi-variable process. There are three interacting domains for research and development: 1) polymeric material technology: introduction of new and improved materials; 2) machine technology: development of machine capability; and 3) processing technology: analysis of the complex interactions of machine and process parameters. As improved product quality and enhanced engineering properties are required of polymeric materials, the injection molding process has become increasingly complex: as service properties increase material processability tends to decrease.

Thermoplastics can be classified as bulk or engineering materials. Engineering materials are typically more difficult to process, and more expensive, and therefore their processing would benefit the most from automated molding optimization (AMO). Injection molding is a batch operation, so machine set-up ultimately affects productivity.

Any molding operation should aim to manufacture component products to a specific quality level, in the shortest time, in a repeatable and fully automatic cycle. Injection molding machines usually provide velocity control and pressure control, that is, control of the velocity of the injection screw when filling the part and control of the pressure exerted by injection screw when packing/holding the part, respectively. The following description assumes the use of a modern injection molding machine, after circa 1980, with velocity control of the mold filling and pressure control of the packing/holding stages.

The typical injection molding cycle is as follows: 1) Plasticisation Stage: plasticisation occurs as the screw rotates, pressure develops against the ‘closed-off nozzle and the screw moves backwards (reciprocates’) to accumulate a fresh shot (the molten polymer in front the screw), ready for injection of melt in front of the screw tip. Back pressure determines the amount of work done on the polymer melt during plasticisation. Polymer melt is forced through the screw non-return valve. Material is fed to the screw by gravity from a hopper. The polymeric material may require conditioning, especially in the case of engineering thermoplastics, to ensure melt homogeneity and therefore that the melt has consistent flow characteristics.

2) Injection/Filling Stage: the empty mold is closed, and a ‘shot’ of polymer melt is ready in the injection unit, in front of the screw. Injection/filling occurs, polymer melt is forced though the nozzle, runner, gate and into the mold cavity. The screw non-return valve closes and prevents back-flow of polymer melt. In this, the mold filling part of the injection molding cycle, high pressures of the order of 100 MPa are often required to achieve the required injection velocity.

3) Packing/Compression Stage: a packing pressure occurs at a specified VP or ‘switch-over’ point. This is the velocity control to pressure control transfer point, i.e. the point at which the injection molding machine switches from velocity control to pressure control. ‘Switch-over’ should preferably occur when the mold cavity is approximately full, to promote efficient packing. The switch-over from injection to packing is typically initiated by screw position. Switch-over can be initiated by pressure, i.e. hydraulic, nozzle melt injection pressures or cavity melt pressure parameters measured from the machine. The end of this stage is referred to as ‘pack time’ or ‘packing time’.

4) Holding Stage: a second stage pressure occurs after the initial packing pressure and is necessary during the early stages of the cooling of the molded part to counteract polymer contraction. It is required until the mold gate freezes; the injection pressure can then be released. This phase compensates for material shrinkage, by forcing more material into the mold. Typical industrial machine settings use one secondary pressure, combining the packing and holding phases, to allow for easier machine set-up. It has been shown that under packing results in premature shrinkage, which may lead to dimensional variation and sink marks. Over packing may cause premature opening of the tool (i.e. the die or mold of the component(s) to be manufactured) in a phenomenon known as flashing, difficulties in part removal (sticking) and excessive residual stresses resulting in warpage. Analysis of the packing phase is therefore an essential step in predicting the final product quality. The portion of filling after switch-over can be more important than the velocity controlled primary injection stage. The end of this stage is known as ‘hold time’ or ‘holding time’.

5) Cooling Stage: This phase starts as soon as the polymer melt is injected into the cavity. The polymer melt begins to solidify when in contact with the cavity surface. Estimating cooling time is becoming increasingly important, especially when large numbers of components are being molded. In order to calculate cooling time, component ejection temperature should be known. Cooling an injection molded product uniformly may mean cooling the mold at different rates, in different areas. The aim is to cool the product as quickly as possible, while ensuring that faults such as poor surface appearance and changes in physical properties are not encountered. The aims for a cooling system are: (i) minimum cooling time, (ii) even cooling on part surfaces, and (iii) balanced cooling between a core and a cavity part of a two-plate tool system. Tool temperature control is required to maintain a temperature differential AT between the tool and the polymer melt. For example, a typical polyoxymethylene melt temperature is 215.degree. C., tool temperature is 70.degree. C., and hence .DELTA.T=145.degree. C. Adverse effects to product quality must be expected for no or poor temperature control. The cooling phase enables the polymer melt to solidify in the impression, owing to the heat transfer from the molded product to the tool. The tool temperature influences the rate at which heat is transferred from the polymer melt to the tool. The differences in heat transfer rate influence polymer melt shrinkage, which in turn influences product density. This effect influences product weight, dimensions, micro-structure and surface finish. The tool cavity surface temperature is critical to the processing and quality of injection molded components. Each part of the product should be cooled at the same rate, which often means that non-uniform cooling must be applied to the tool. Thus, for example, cool water should be fed into the inner parts of the tool cooling system (particularly in the area of the gate) and warmer water should be fed into the outer parts. This technique is essential when molding flat components to close tolerances, or large components that include long melt flow lengths from the gating position. Tool design must thus preferably incorporate adequate temperature control zones (flow ways), to provide the desired tool temperature. Tool temperature control zones commonly use water for temperatures up to 100.degree. C., above which oil or electrical heating is used.

As described in U.S. Pat. No. 9,346,201 (i.e. '201 patent): vehicle interiors may generally include a number of trim elements in the form of injection-molded panels or inserts that are attached over various internal or structural components of the vehicle. Such panels may provide a finished appearance for the vehicle interior by covering the structural or internal components of the vehicle from view. Such panels are often attached to the structural vehicle element that they conceal, which may be achieved by one or more specifically-structured features of the panel that are integral with the side thereof opposite the visible surface. Such features may be of the type generally referred to as a “dog house,” which may define a multi-walled structure extending from a surface of the panel to contact the feature to which the panel is to be attached. Dog houses are generally configured to receive a mechanical fastener or to provide a surface on which adhesive can be applied to couple the dog house, and thus the panel, to the structural vehicle component.

Because the panels and various dog houses are integrally injection-molded in a single piece, part sink or read-through may occur in the area of dog houses, making their locations visible on the surface of the panel opposite the dog house, otherwise referred to as the “class-A” surface. This occurs because the molten plastic used to injection mold the panel shrinks as it cools. When the plastic forming the dog house shrinks, it pulls on the adjacent portion of the panel body, resulting in a depression on the opposite, class-A, surface, in a location that is visible to the customer.

Various modifications to dog house structures have been made in an effort to reduce read-though on finished part surfaces. In general, such modifications have involved thinning of the various walls of the dog house in an effort to reduce material. However, such thinning may weaken the structure of the dog house, adversely affecting the strength of the attachment to the associated structural vehicle element.

The '201 patent describes a method to reduce read-through on a vehicle surface of an injection molded panel for a vehicle interior. The method includes injecting molten plastic into a mold to partially surround a lifter positioned within a cavity defined between first and second mold parts so as to include surrounding a plurality of pins extending from the lifter toward a wall of the cavity. The method also includes cooling the molten plastic into the panel and removing the panel from the mold at least by movement of the lifter from out of the cavity.

As described in U.S. Pat. No. 6,196,687, when plastic parts need to be secured together, especially in automotive applications, it is often times desirable to use pin fasteners such as push pins rather than screws to make the assembly easier, simpler, less costly and more cosmetically pleasing to the OEM design studio and consumer.

Such a push pin is typically used with a hollow connector portion commonly called a “dog house”, which is integrally formed on an inner surface of one of the plastic parts such as a plastic interior trim panel. The trim panel includes a plastic main section and a plastic auxiliary or “flag” section. Use of such “dog houses” and associated push pins produce hidden attachment mechanisms for the plastic parts.

It is generally not difficult to form the connector portions on an inner surface of the main section. However, for tooling reasons, such a “dog house” or connector portion typically cannot be formed on an inner surface of the flag section. Specifically, the tooling problem is a “locked” lifter or “die lock” condition. Such lifters, which are located within the mold, are used to form the connector portions.

Because of this tooling problem, a screw may be inserted through an outer surface of the flag section to fasten the flag section to a corresponding portion of a metallic door inner panel. However, the outer surface of the flag section is a “Class A” surface. Consequently, the screw mars the outer surface.

U.S. Pat. No. 5,501,829 discloses a method of manufacturing trim panels for vehicle doors.

U.S. Pat. No. 5,820,191 discloses a structural inner-door panel for a vehicle that is monolithic and molded as a single piece of polymeric material.

U.S. Pat. No. 5,603,548 discloses an automobile door having an interior trim panel that is connected to a rigid inner structure.

U.S. Pat. No. 5,584,144 discloses a motor vehicle door having an inner panel including an integral mounting base for fastening the bottom of a door pocket to the panel.

U.S. Pat. No. 5,529,370 discloses a trim panel mounting assembly including a trim panel bracket and a support bracket.

U.S. Pat. No. 5,419,606 discloses a trim panel having pins for attaching it to a door panel.

U.S. Pat. No. 4,949,508 discloses a door assembly having a trim panel that is secured by pins.

U.S. Pat. No. 4,845,894 discloses a method for mounting an outer skin to an inner panel of a vehicle door.

Other related U.S. patents includes U.S. Pat. Nos. 4,214,788; 4,270,328; 4,472,918; 4,505,611; 4,568,215; 4,717,301; 4,957,326; 5,419,606; 5,752,356; 5,833,303; 5,865,500; 5,935,729 and 5,992,914.

As described in U.S. Pat. No. 6,467,801, improvements continue to be made on vehicle air bag deployment systems for vehicle impact situations. Many current air bag deployment systems are configured to deploy an air bag through a panel member of a vehicle during impact of the vehicle. Many such deployment systems are disposed on a front panel member of a vehicle to dissipate impact energy on the front panel member during impact of the vehicle. Typically, the front panel member to which such deployment system is attached includes a visible tear seam outlining an area through which an air bag deploys upon impact of the vehicle. In many situations, the front panel member has an opening formed therein to define the tear seam and thus the area through which the air bag may be deployed. The panel member further includes a door portion disposed within the opening to define a visible space or notch between the periphery of the door portion and the opening. The door portion is pivotally attached to an edge or side of the opening to hinge the door portion to the panel member. Thus, during air bag deployment, the door portion pivots away from the panel member, allowing the air bag to be deployed into a vehicle compartment. In many situations, a break-away skin material is disposed over the panel member to add an aesthetic feel and look to the panel. However, the visible notch between the door portion and the panel, in many cases, can be seen by an occupant of the vehicle.

One goal of an instrument manufacturer is to provide a seamless panel member having an air bag deployment system attached thereto while providing adequate air bag deployment during vehicle impact. As described above, many panel members have pivotally attached door portions which require a visible tear seam on its outer surface. Some panel members include break-away or tear seam portions molded to the panel member and door portion, and are comprised of different material than the panel member or door portion to provide a weakened area through which an air bag may be deployed during a vehicle impact. However, the different materials used often result in different shades of pigment, allowing visibility of the door portion.

Moreover, many panel members are configured with tear seams which, upon force placed thereon, may break and cause the door portion to pivotally move toward the air bag. In such event, the panel member is required to be replaced. This, obviously, is time consuming and high in cost.

U.S. Pat. No. 6,467,801 discloses an air bag deployment chute having a door portion and an opening through which the door portion may pivot away from an air bag during deployment. A panel member is attached to the deployment chute for deploying the air bag through the panel member during impact of the vehicle. The panel member has a groove formed on an inner surface of the panel member to define a seam which is not visible on an outer surface of the panel member. The opening of the deployment chute is formed within the groove of the panel member to prevent pivotal movement of the deployment chute toward the air bag.

U.S. Pat. No. 8,336,908 discloses a hidden air bag deployment door formed by an instrument panel substrate and a molded air bag chute. As described in the '908 patent, a common material for an instrument panel substrate is injection molded thermoplastic. However, when a tear seam is in-molded in such a substrate, a potential problem occurs that is known as read-through. In read-through, the narrowed thickness of the substrate at the in-molded seam causes visible distortion in the form of a groove on the Class A surface that forms during cooling of the molded material. Therefore, secondary operations have been required such as either 1) laser scoring or milling to cut a pre-weakened seam in the Class B surface that cannot be seen from the Class A surface, or 2) allowing the read-through to occur but then covering the instrument panel substrate with an outer skin layer to hide the read-through seam. The secondary operations increase manufacturing and/or material costs.

Another issue relating to conventional chute assemblies is the need to attach the chute to the instrument panel substrate. One common method to attach a chute has been vibration welding, but the known processes can be costly and it has been difficult to obtain a desired robustness of the attachment.

The instrument panel substrate of the '908 patent comprises a first moldable thermoplastic characterized by a first melting temperature. The instrument panel substrate has a substantially smooth outer surface for facing a passenger compartment of the vehicle. A chute comprises a second moldable thermoplastic characterized by a second melting temperature lower than the first melting temperature. The chute includes an in-mold tear seam and a hinge for an air bag deployment door and a passageway for guiding an inflating air bag to the deployment door. The chute is attached to an inner surface of the instrument panel substrate by insert molding in which injection of the first moldable thermoplastic caused a partial melting of the second moldable thermoplastic.

As described in the '908 patent, in some instances substrate defects can still be apparent through a cover layer including an elastomeric skin and a layer of foam between the skin and the substrate.

U.S. Pat. No. 9,481,337 discloses multiple methods including a method of manufacturing a vehicle trim component configured to support an airbag module providing an airbag. The method includes disposing a fiber panel onto a first surface of a mold and compressing the fiber panel between the first surface and a second surface of the mold to form the fiber panel into a compression formed component having a shape. The shape corresponds to a first contour of the first surface and a second contour of the second surface. The method further includes injecting a resin into the mold after the compression formed component is formed to fill at least one void to form a structure on a side of the fiber panel. The method then includes removing the vehicle trim component from the mold. The panel comprises a material formed at least partially from fibers. The structure is configured to support the airbag module and to direct the airbag toward the fiber panel during deployment of the airbag. Coverstock is disposed onto an outer surface of the trim component.

U.S. Published Application No. 2017/0036638 provides a similar disclosure.

A wide variety of welding technologies exist to join or bond plastic components together such as: ultrasonic welding; vibration welding; thermal welding; spin welding; infrared welding; hot plate welding; and laser welding. U.S. Pat. Nos. 6,066,217 and 5,026,445 are examples of such welding technologies.

Also, a wide variety of adhesives such as liquid and heat-sensitive solid film adhesive may be used to join plastic components together. Oftentimes a mold is used in the bonding process. U.S. Pat. Nos. 8,133,419; 5,534,097 and U.S. patent document 2011/0315310 are examples.

It is often desirable to attach or bond a plastic component to a carpeted component. Such carpeted plastic components are shown or described in the following U.S. Pat. Nos. 5,026,445; 6,050,630; 6,537,413; 6,748,876; 6,823,803; 7,919,031; and 7,909,379; and U.S. patent document 2005/0189674.

U.S. published patent application 2013/0333837 discloses a method of bonding a thermoplastic component to a carpeted component. The method includes providing a base component, a thermoplastic component and a fibrous carpet or mat between the components. The carpet has a large number of cavities. The carpet is made of a thermoplastic material adapted to bond to the thermoplastic component in response to heat at the interface between the thermoplastic component and the carpet. The method also includes heating the thermoplastic component and the carpet at the interface between the thermoplastic component and the carpet for a period of time to soften the carpet. The method finally includes pressing the components and the softened carpet together under a pressure to cause the softened carpet to flow and at least partially fill the cavities. The carpet at the interface is transformed into a solid bonding layer to bond the components together to create a finished structure.

### SUMMARY

An object of at least any embodiment of the invention is to provide a low cost, time saving molding method of making a vehicle interior component having an integral airbag component.

In carrying out the above object and other objects of at least one embodiment of the present invention, a method of making a vehicle interior component having an integral airbag component is provided. The method comprises disposing a polymeric composite sheet having inner and outer surfaces onto a first surface of a mold at a molding station and compressing the sheet between the first surface and a second surface of the mold at the molding station. The method also includes injecting a molten polymer compatible with the polymeric material of the composite sheet into the mold cavity in accordance with a predetermined set of process parameters which are high enough to integrally form at least one airbag component via polymeric interfusion at the inner surface of the composite sheet but not low enough to reduce surface defects on the outer surface of the composite sheet.

The process parameters may include material packing pressure.

The process parameters may include material injection pressure.

The process parameters may include material injection temperature.

The process parameters may include a time delay between the step of compressing and the step of injecting.

The interior component may be a panel.

The panel may be an instrument panel.

The at least one airbag component may include an airbag deployment chute.

The surface defects may include part sink or read-through.

The polymeric material of the sheet may be a thermoplastic.

### BRIEF DESCRIPTION OF THE DRAWINGS

FIG. 1 is a schematic perspective view of an “A” side of a vacuum-injection-compression (VIC) molded upper interior vehicle door panel without its laminated outer facing material;

FIG. 2 is a schematic perspective view of a “B” side of the panel of FIG. 1 and illustrating a plurality of injection molded plastic components thereon;

FIG. 3 is a schematic perspective view of the components of FIG. 2 and molded flow “runners” including “drops” separate from the panel of FIGS. 1 and 2;

FIG. 4A is a side view, partially broken away and in cross section, showing an open compression mold and conveyors for conveying heated sheets of composite and laminated sheets between the mold halves of the mold at a first mold station to make the panel of FIGS. 1 and 2 together with the laminated outer facing material;

FIG. 4B is a view similar to the view of FIG. 4A but with the mold in its closed position and further illustrating a vacuum source under control of a controller for applying a vacuum to the laminated sheet;

FIG. 4C is a view similar to the view of FIG. 4B but further showing the injection of molten resin in the lower mold half to form the plastic components and runners on the “B” surface;

FIG. 4D is a view similar to the view of FIGS. 4A-4C wherein in the upper right portion thereof the molded component does not have components bonded thereto at the first molding station on the left but rather has the injection molded components bonded thereto at a second molding station after conveyance thereto by a conveyor; alternatively, in the lower right portion of FIG. 4D the component with the bonded injection molded components from the first molding station is transferred to one or more trim, edge, fold and finish stations by a conveyor to complete the manufacturing process;

FIG. 5A is a view similar to the view of FIG. 4A but the upper mold half also supports trimming parts in the form of blades to trim the component to form the vehicle door panel;

FIG. 5B is a view similar to the view of FIG. 4B wherein the mold of FIG. 5A is in its closed position;

FIG. 5C is a view similar to the view of FIG. 4C wherein the mold of FIGS. 5A and 5B has molten resin injected into its lower mold half;

FIG. 5D is a view of the mold of FIGS. 5A-5C with the trimming parts moved to their extended positions by an actuator under control of a controller;

FIG. 5E is a view of the mold of FIGS. 5C-5D in its open position with a trimmed, molded part between the mold halves;

FIG. 5F is a view of the mold of FIGS. 5A-5E with the trimmed, molded part of FIG. 5E transferred out of the first mold station by a conveyor;

FIG. 5G is a view of the trimmed, molded part of FIG. 5F being further trimmed at a trimming station by an industrial robot with pressurized fluid;

FIG. 6A is an enlarged view, partially broken away and in cross section, of a compressed outer peripheral portion of the door panel enclosed by the circle of FIG. 4C with mold half portions and a cutting tool in the lower mold half;

FIG. 6B is a view similar to the view of FIG. 6A but showing a different compressed outer peripheral portion of the door panel with mold half portions;

FIG. 6C is a view similar to the views of FIGS. 6A and 6B but showing yet another different compressed outer peripheral portion of the door panel with mold half portions and a cutting tool in the lower mold half;

FIG. 7 is a schematic perspective view, partially broken away and in cross section, of an outer peripheral portion of the door panel with the compressed composite sheet folded over and bonded to the “B” surface of the panel;

FIG. 8 is a view similar to the view of FIG. 7 with an outer peripheral portion of a cushioning layer of the laminated sheet removed;

FIG. 9 is a schematic perspective view of an “A” side of a hybrid injection-compression molded upper interior vehicle door panel with its laminated outer facing carpeting or fabric wherein openings for hardware still need to be trimmed out;

FIG. 10 is a schematic perspective view similar to the view of FIG. 9 but at a slightly different angle;

FIG. 11 is a schematic perspective view of a “B’ side of the panel of FIGS. 9 and 10 illustrating a plurality of injection molded components therein;

FIG. 12 is a view similar to the view of 11 but at a slightly different angle;

FIG. 13 is an enlarged schematic perspective view, partially broken away, of the “B” side of the panel of FIGS. 9-12;

FIGS. 14-18 relate to a panel constructed in accordance with another embodiment wherein FIG. 14 is a schematic perspective view of the “A” side;

FIG. 15 is a schematic perspective view similar to the view of FIG. 14 but at a slightly different angle;

FIG. 16 is a schematic perspective view of a “B” side of the panel of FIGS. 14 and 15 illustrating a plurality of injection molded components therein;

FIGS. 17 and 18 are views similar to the view of FIG. 16 but at slightly different angles and illustrating drops for forming the injection molded components;

FIG. 19 is a side elevational view of as “A” side of a panel constructed in accordance with yet another embodiment of the invention;

FIG. 20 is an enlarged, schematic perspective view, partially broken away, of the “B” side of the panel of FIG. 19;

FIG. 21 is an end view, partially broken away, of the panel of FIGS. 19 and 20 with the carpet or fabric layer folded or wrapped around the composite layer;

FIG. 22 is a schematic perspective view of the “A” side of a compression molded composite sheet for yet another embodiment;

FIG. 23 is a view similar to the view of FIG. 22 but at a slightly different angle;

FIGS. 24 and 25 are schematic perspective views of a “B” side of the panel of FIG. 23 and illustrating a plurality of drops for forming the injection molded components on the “B” side;

FIG. 26 is a view, partially broken away and in cross section, of one of the panels of FIGS. 9-25 with its carpet or fabric layer folded over its composite sheet;

FIG. 27 is a sectional view, partially broken away and in cross section of a prior art automotive trim panel assembly disclosed in U.S. Pat. No. 6,196,607;

FIG. 28 is a sectional view illustrating movable tooling such as a lifter to cover coverstock material to create a new tool surface which allows for coverstock separation from the molded composite sheet for folding purposes;

FIG. 29 is a schematic perspective view of the “A” side of an air bag deployment panel which has been formed via compression and injection molding in accordance with at least one embodiment of the present invention to include an airbag deployment chute on its “B” side; and

FIG. 30 is a cross sectional view of the air bag deployment panel of FIG. 29 illustrating the airbag chute formed by injection molding on the “B” side of the composite panel and an airbag illustrated by phantom lines.

### DETAILED DESCRIPTION

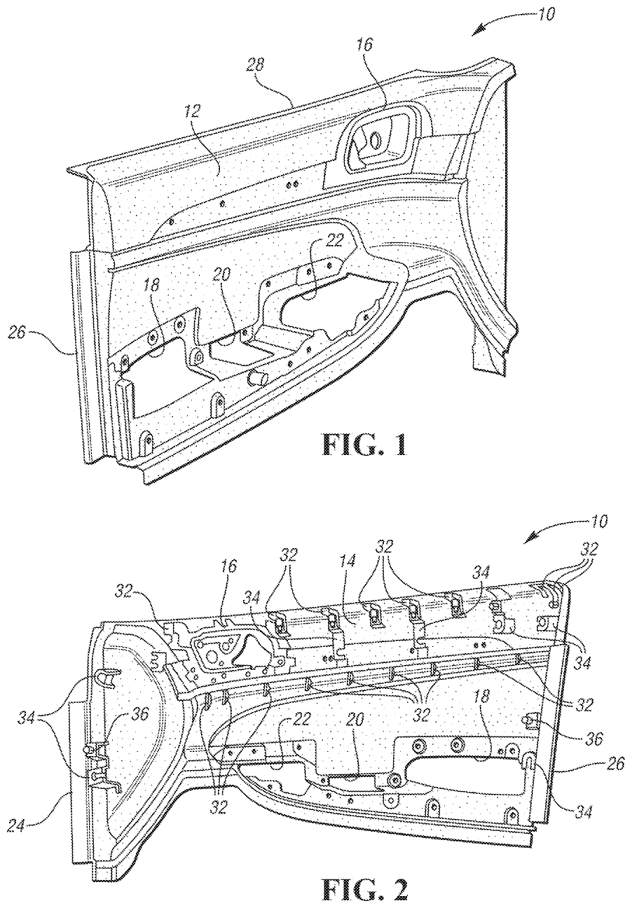

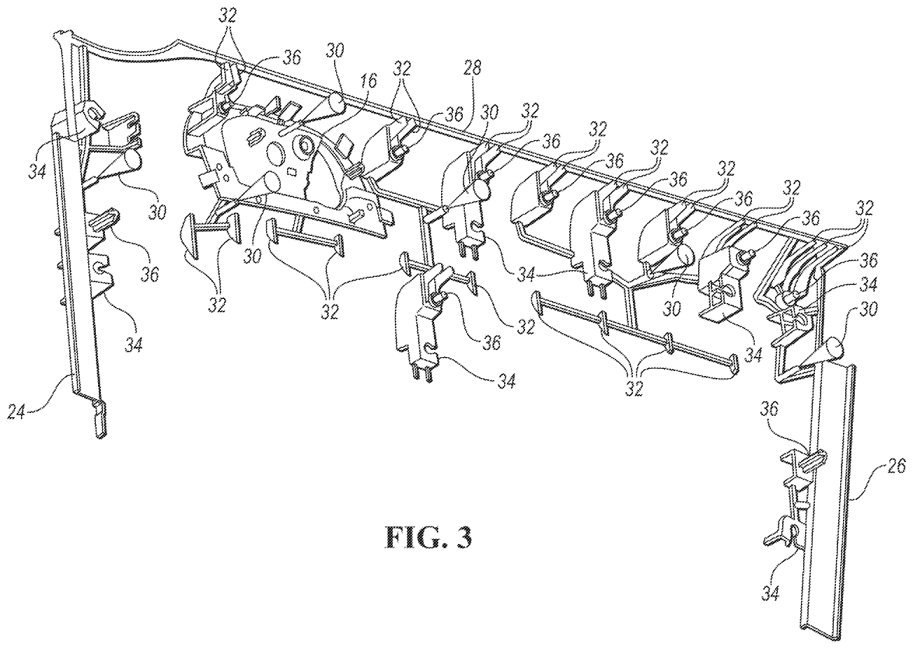

At least one embodiment of the present invention provides a method of making a laminated trim component, such as vehicle trim component or upper interior door panel, generally indicated at 10 in FIGS. 1 and 2. The panel 10 has an inner “A” surface 12 and an outer “B” surface 14. The panel 10 includes a number of apertures 16, 18, 20 and 22 which receive and retain a number of different automotive components. The panel 10 includes a plurality of edge components 24, 26 and 28 which are made from plastic resin which initially flows from “drops” 30 (FIG. 3) to stiffening ribs 32, receptacles 34 and posts 36 to provide attachment locations for various automotive components including wiring harnesses, etc. on the “B” surface 14 of the panel 10.

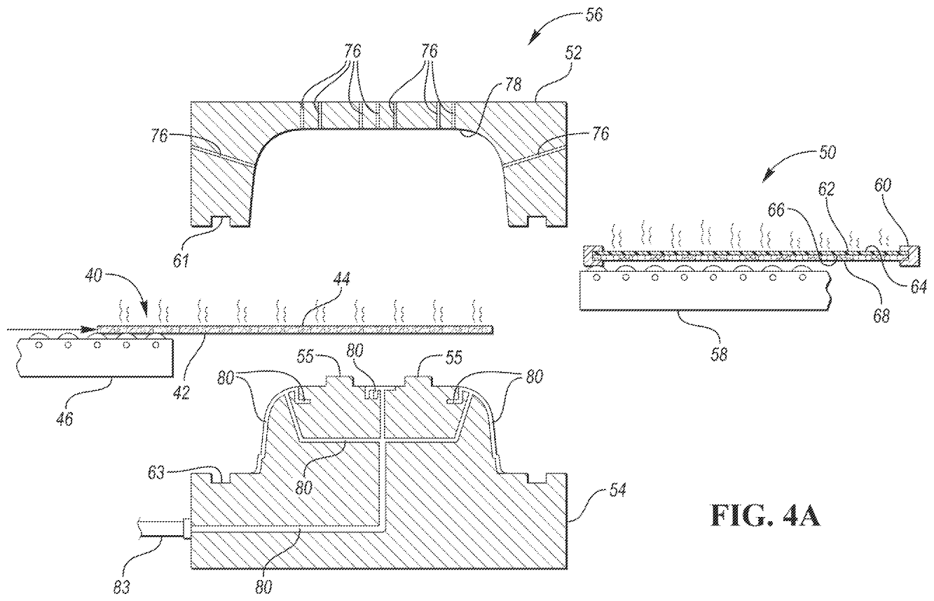

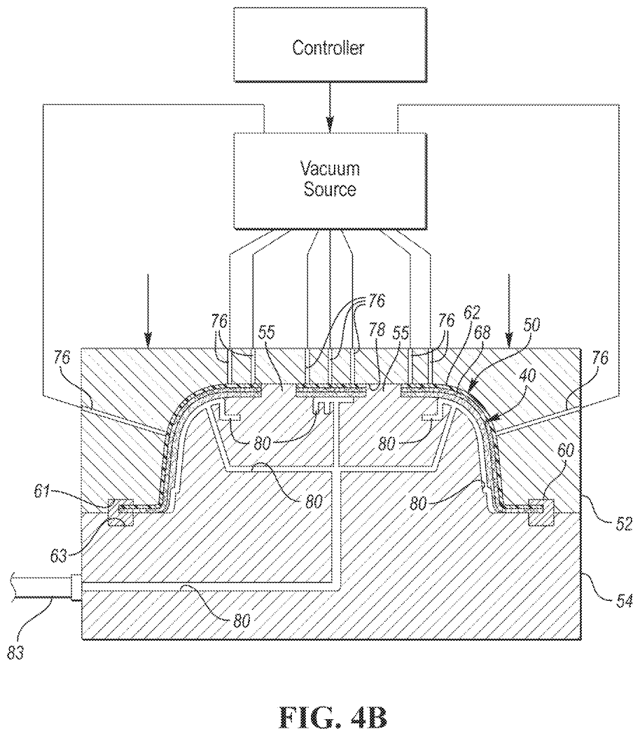

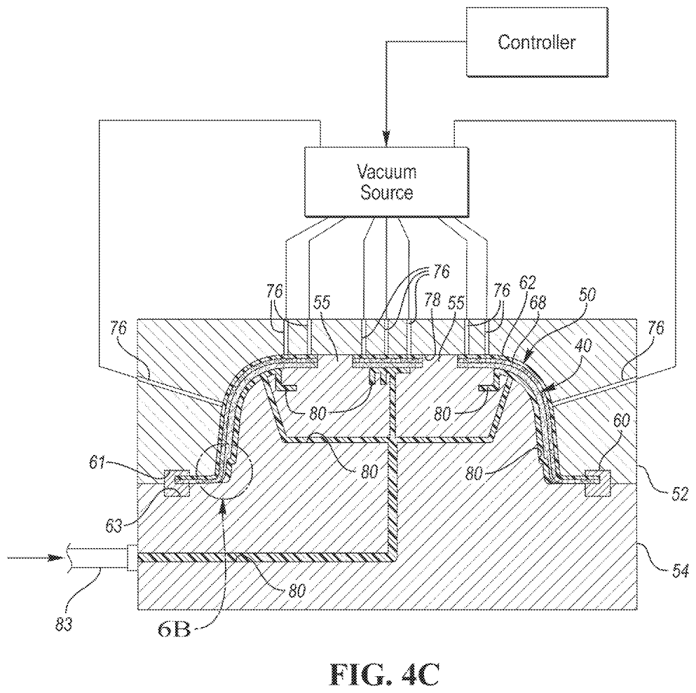

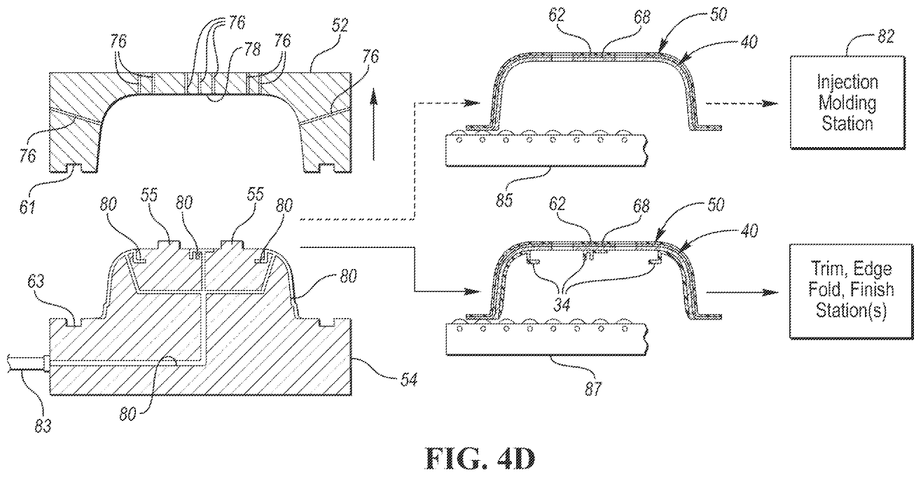

Referring now to FIGS. 4A-4D, the method includes providing a natural fiber, plastic composite sheet or substrate, generally indicated at 40, having inner and outer surfaces 42 and 44, respectively. Substrates of fibrous molding material have a few advantages over plastics. For example, a considerable portion of fibrous molding materials is produced of renewable resources such as conifers, hemp or kenaf. Technical and economical considerations also fuel the trend toward fibrous molding materials. At the same specific rigidity, fibrous molding materials have a lower weight than glass fiber-polypropylene composites or talcum-polypropylene composites. Substrates of fibrous molding materials are distinguished by their favorable crash and splintering characteristics, their sound energy and acoustic absorption (also at cold temperatures) and a comparatively low coefficient of thermal expansion. The industry has many years of experience with the processing of fibrous molding materials, wherein the corresponding processes and hot-pressing molds are respectively robust and cost-efficient in comparison with injection molds. Fibrous molding materials allow the manufacture of substrates with highly pronounced undercuts and changes in direction with an angle of up to 180 degrees. Furthermore, wood fibers and natural fibers are available in large quantities, wherein their price is also less dependent on the price of crude oil than petroleum-based plastics.

The composite sheet 40 is heated in an oven (now shown) while on a conveyor 46 to a first softening temperature. The composite sheet 40 is stretchable when heated to the first softening temperature. The heated composite sheet 40 is transferred or conveyed by a conveyor 46 to a position between mold halves 52 and 54 of a compression mold, generally indicated at 56. The heated composite sheet 40 may then be molded into the shape defined by the mold halves 52 and 54 at that time or can be molded together with a laminated sheet, generally indicated at 50 in FIG. 4A. The lower mold 54 may have raised portions 55 to help form the panel 10.

The laminated sheet 50 overlies the outer surface 44 of the composite sheet 40 after the sheet 40 is in its molded or unmolded condition. Like the sheet 40, the sheet 50 is transported between the mold halves 52 and 54 of the compression mold 56 by a conveyor 58. Because the sheet 50 is flexible, the sheet 50 is supported by a frame 60. The laminated sheet 50 has a support layer 62 with inner and outer surfaces and a plastic cushioning or foam layer 68 laminated to the support layer 62 at the inner surface 66 of the support layer 62.

The foam layer 68 may be cross-linked polypropylene (XLPP) foam and the support or outer skin layer 62 may be suitable thermoplastic materials including but are not limited to polyethylene-based polyolefin elastomer or polypropylene-based thermoplastic elastomer, poly-urethane resins and other co-polymers and equivalents thereof. Non-limiting examples include; thermoplastic elastic olefin (TEO), thermoplastic elastomer (TPE), thermoplastic elastomer—oefinic (TPE-O, TPO), thermoplastic elastomer—styrenic (TPE-S), Polycarbonate (PC), Polycarbonate/Acrylonitrile-Butadiene-Styrene (PC/AB S), Acrylonitrile-Butadiene-Styrene (AB S) copolymers, Poly-urethane (TPU) and Polyvinyl-Chloride (PVC). The outer skin layer may also be vinyl or leather.

The laminated sheet 50 is heated to a second softening temperature in an oven (not shown) while being supported by the frame 60. The laminated sheet 50 is stretchable when heated to the second softening temperature.

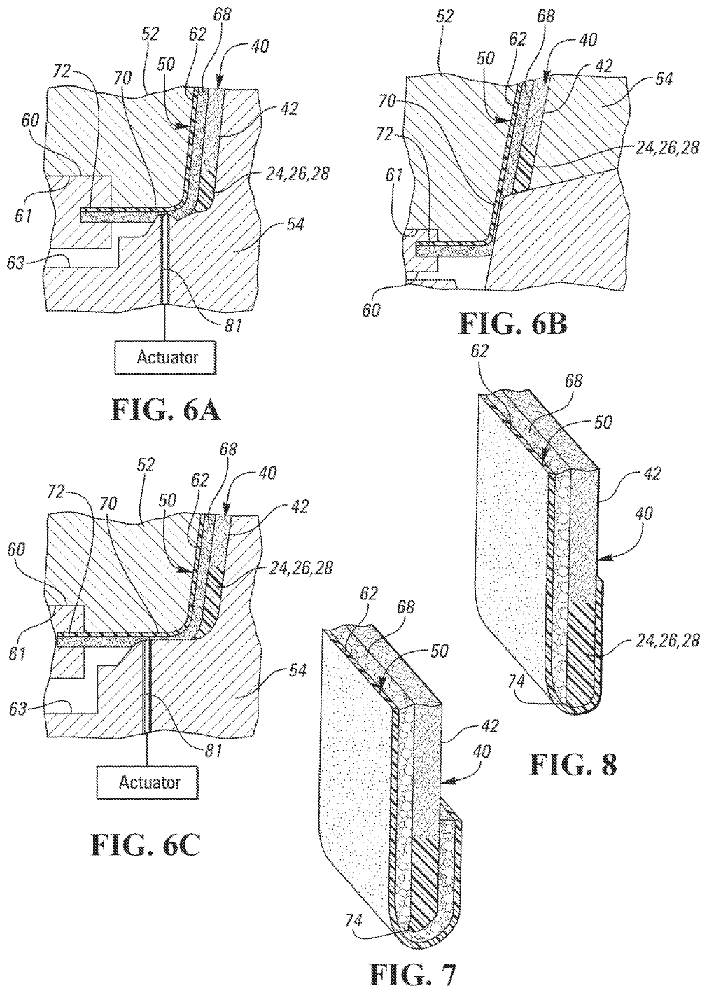

Referring specifically to FIG. 4B, the composite sheet 40 is pressed against the laminated sheet 50 after the steps of providing and the steps of heating to bond the plastic cushioning layer 68 to the plastic composite sheet 40. The plastics of the layer 68 and the sheet 40 are compatible to permit such bonding. As shown in FIGS. 6a-6C, the step of pressing compresses a portion 70 of the laminated sheet 50 spaced inwardly from an outer periphery 72 of the laminated sheet 50 to locally compact and thin the cushioning layer 68 at the portion 70 to form a compressed portion 74 (FIG. 7) of the cushioning layer 68 between uncompressed portions of the cushioning layer 68. Interior portions of the sheets 40 and 50 stretch during the step of pressing while remaining intact. During the pressing step the frame 60 is secured within slots 61 and 63 machined in the upper and lower mold halves 52 and 54, respectively.

Referring again to FIGS. 4A-4D, the method further includes applying a vacuum at the outer surface 64 of the support layer 62 to pull the outer surface 64 of the support layer 62 into contact with a forming surface 78 of the upper mold half 52 while the support layer 62 is still soft to improve appearance of the outer surface 64 and improve component shape. The vacuum is provided by a vacuum source (FIGS. 4B and 4C) operating through passages 76 and under control of a vacuum controller.

The cushioning support layer 62 preferably is a thermoplastic foam layer compatible with the plastic of the composite sheet 40.

The laminated plastic sheet 50 is preferably a polymer bi-laminate sheet.

The support layer 62 is preferably a thermoplastic outer skin layer 62. The thermoplastic outer skin layer 62 is preferably a TPO outer skin layer.

The composite sheet 40 typically includes a thermoplastic resin. The thermoplastic resin of the composite sheet 40 is preferably polypropylene.

The method may further include folding the laminated sheet 50 at the compressed portion 74 of the cushioning layer 68 and bonding outer peripheral uncompressed portions of the folded laminated sheet 50 to the inner surface 42 of the composite sheet 40 as shown in FIG. 7. Alternatively, outer peripheral portions of the cushioning layer 68 are removed by trimming or cutting blades 81 as shown in FIGS. 6A and 6C supported in the lower mold half 54 and actuated by a blade actuator. The resulting trimmed laminated sheet 50 is then folded over the composite sheet 40 as shown in FIG. 8 wherein the support layer 62 is bound to the inner surface 42 of the composite sheet 40. The trimming and folding may occur in the mold 56 as is well known in the art or may take place outside of the mold 56 as shown in FIG. 4D.

As shown in FIGS. 4A-4D, the lower mold half 54 may include passages 80 for molding a plastic injected by a nozzle 83 into the lower mold half 54. The plastic is compatible with the plastic of the composite sheet 40 to bond the plastics together and is molded around the composite sheet 40 to form at least one component such as the components 24, 26, 28, 32, 34 and 36 at the inner surface 42 of the composite sheet 40 at the first molding station.

The bonded sheets 40 and 50 may be transferred by a conveyor 85 without injection molding at the first molding station to a second molding station 82 as shown in the upper right-hand portion of FIG. 4D. The bonded sheets 40 and 50, alternatively, may be transferred by a conveyor 87 to one or more trim, edge fold, finish stations after injection molding of the plastic components 24, 26, 28, 32, 34 and 36 as shown in the lower right portion of FIG. 4D.

At the second molding station 82, a plastic compatible with the plastic of the composite sheet 40 is molded around the composite sheet 40 to form at least one component such as the components 24, 26, 28, 32, 34 and 36 at the inner surface 42 of the composite sheet 40.

The plurality of plastic edge components 24, 26 and 28 may be formed about the periphery 72 of the composite sheet 40 during the step of injection molding. The method may further include folding the laminated sheet 50 at the compressed portion 70 of the cushioning layer 68 and bonding outer peripheral uncompressed portions of the folded laminated sheet 50 to the plastic edge components 24, 26 and 28.

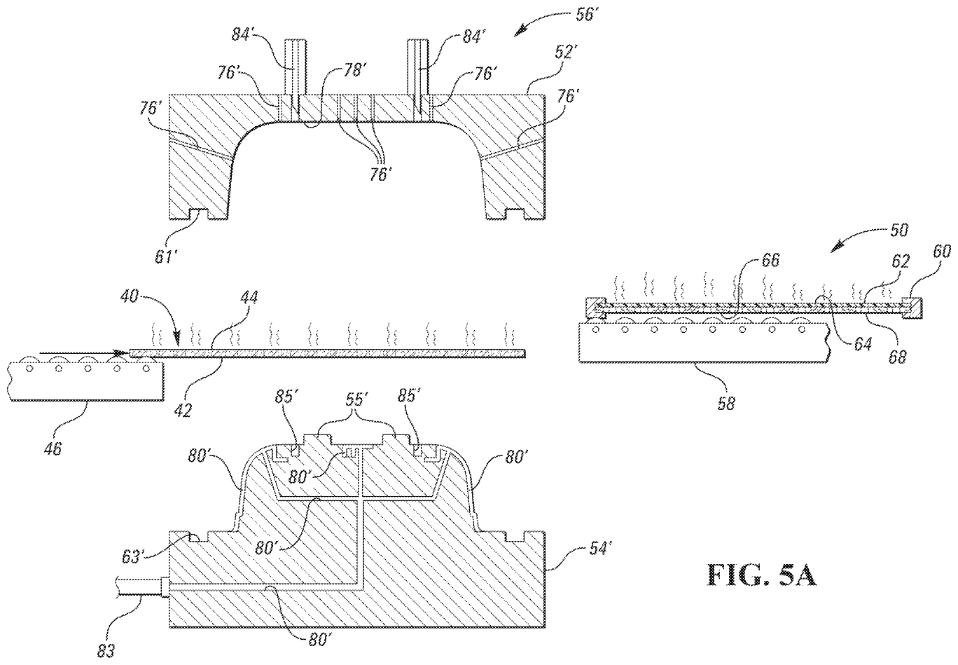

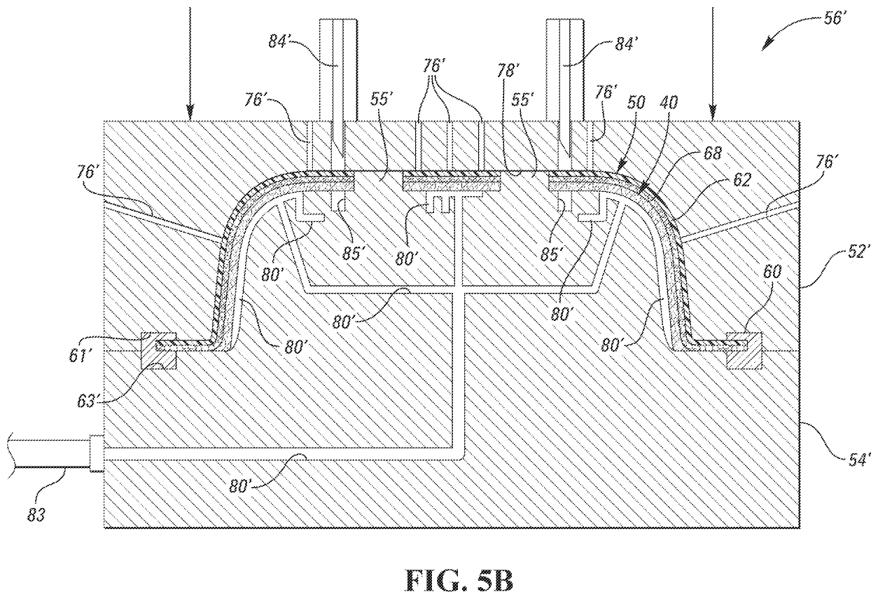

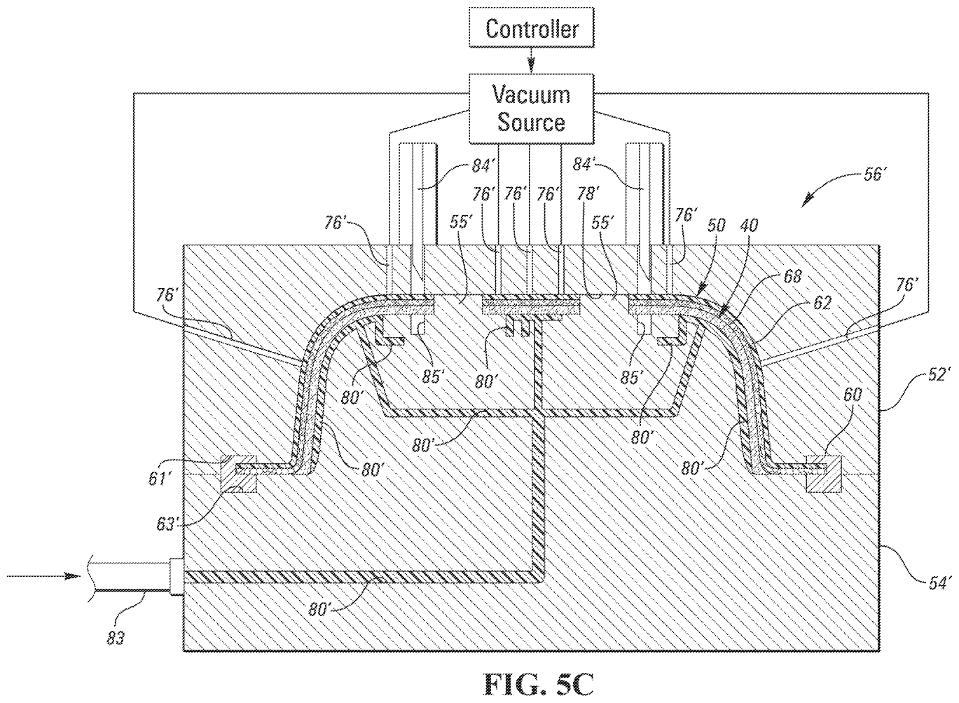

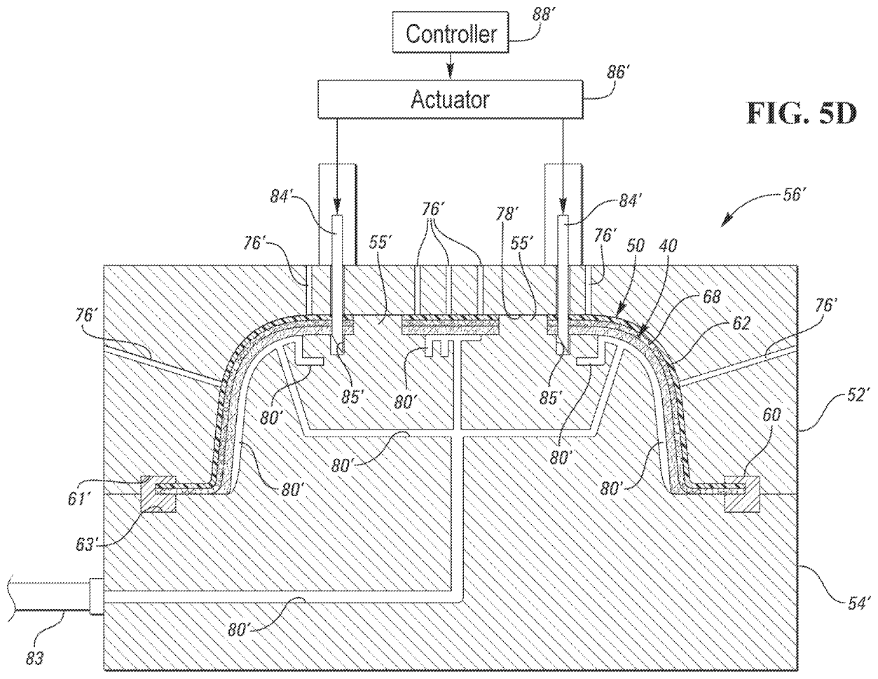

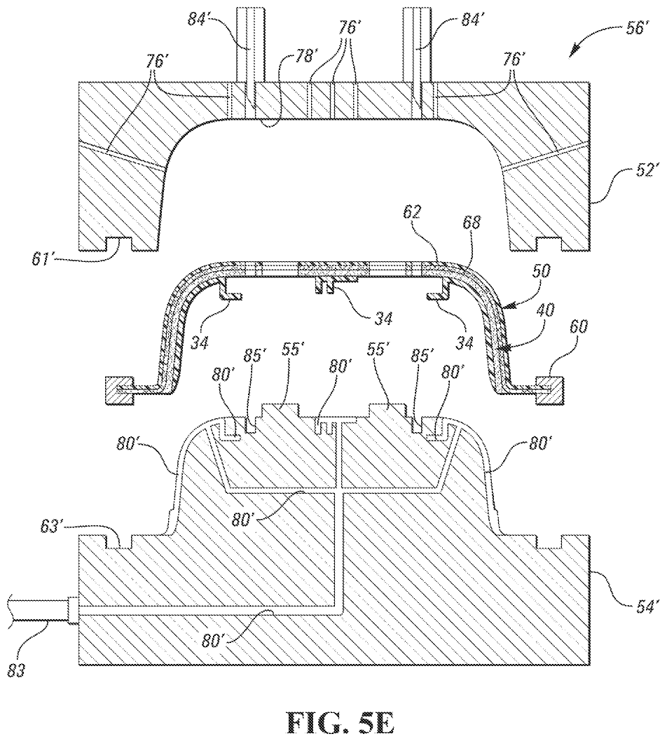

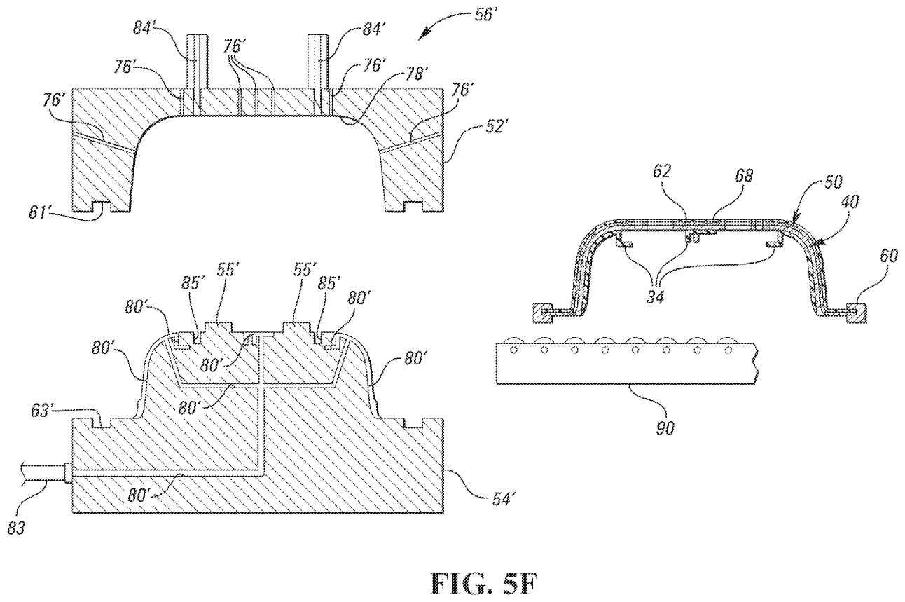

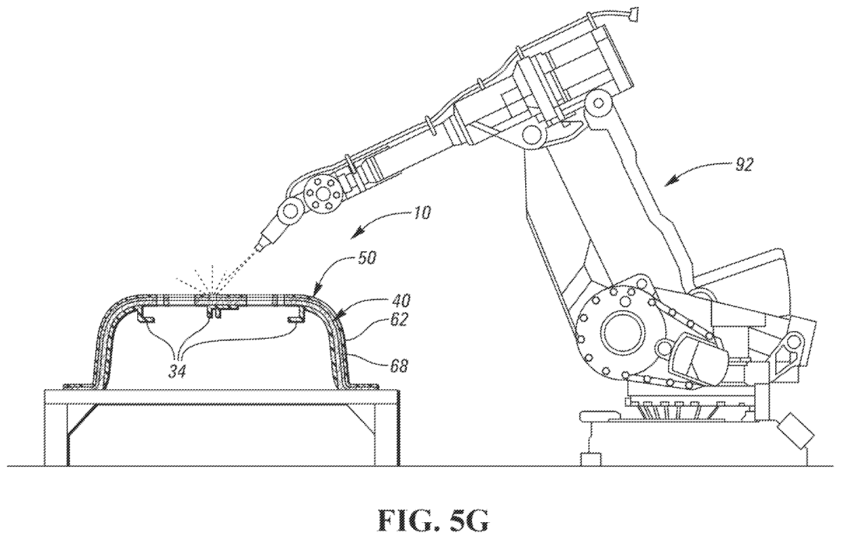

The method also typically includes trimming unwanted portions of the laminated sheet as shown in FIGS. 5A-5G. Trimming may be accomplished by cutting blades 84′ mounted for translational movement in an upper mold half 52′ of a mold 56′. The blades 84′ are moved by an actuator 86′ under control of a controller 88′ as shown in FIGS. 5C and 5D. Apertures 85′ are formed in the lower mold half 54′ to receive the extended blades 84′. The mold 56′ has a single prime designation to distinguish the mold 56′ from the mold 56. However, the parts of the mold 56′ have the same reference number as the parts of the mold 56 to indicate the same or similar structure and/or function.

In FIG. 5F the trimmed panel 10 may be transferred or conveyed by a conveyor 90 to another trimming station as shown in FIG. 5G for further trimming by an industrial robot 92. As shown in FIG. 5G, the panel 10 is trimmed by high pressure water or other fluid as directed by the robot 92. Alternatively, the mold 56′ is not provided with the cutting blades 84′ and all or substantially all of the trimming is performed by the robot 92 or manually.

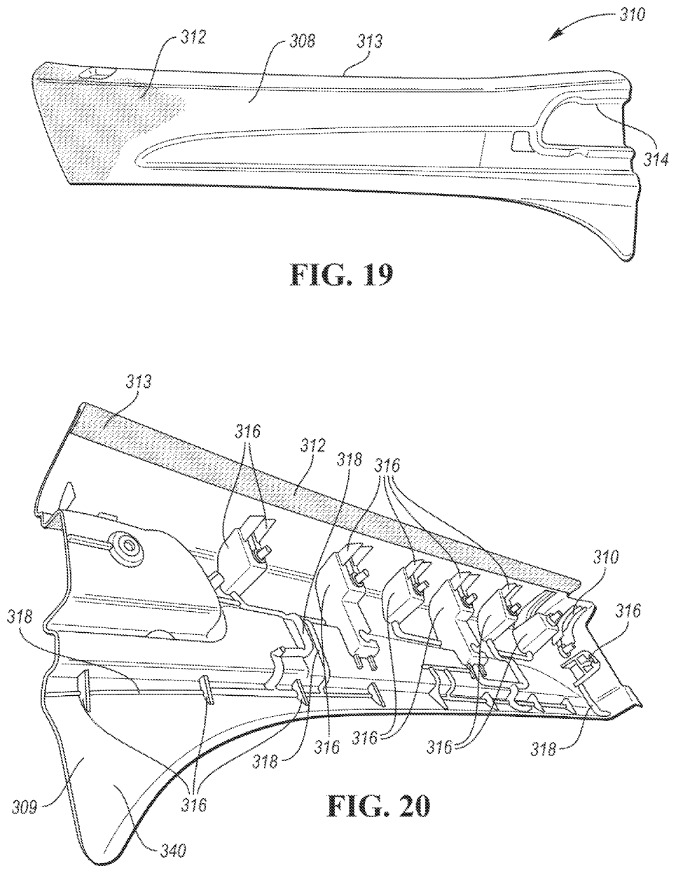

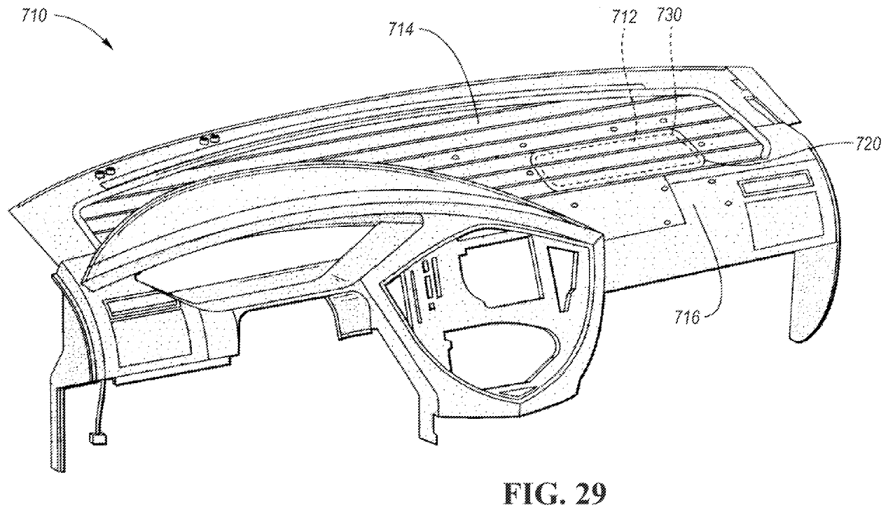

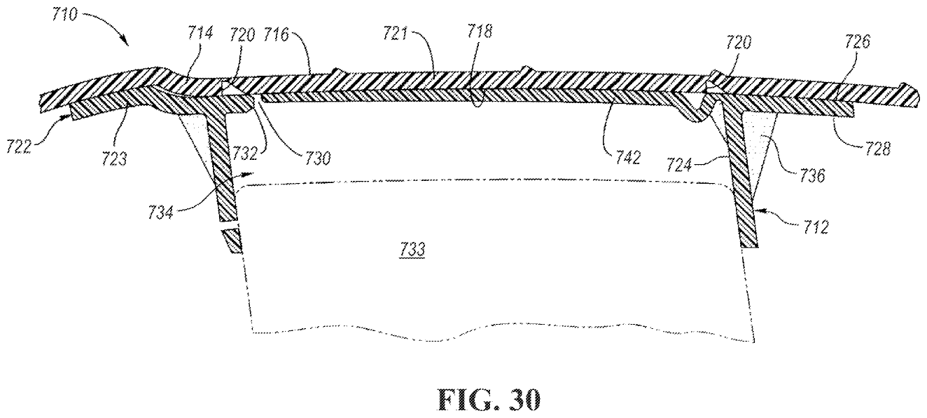

Referring now to FIGS. 9-30 in combination with FIGS. 1-8, there is illustrated various molding methods and apparatus for making trim components such as vehicle interior trim components, generally indicated at 110 (FIGS. 9-13), 210 (FIGS. 14-18), 310 (FIGS. 19-21), 410 (FIGS. 22-25), and 710 (FIGS. 29-30).

One method may be characterized as a compression and injection hybrid process with in mold cover stock. An objective of this method is to combine compression molding, injection molding, and cover stock forming lamination into a one step process.

Generally, this is a method of making a trim component having a fibrous decorative covering. The method includes providing a polymeric composite sheet having inner and outer surfaces and providing a fibrous decorative covering overlying the outer surface of the composite sheet. The method also includes pressing, in a mold cavity at a molding station, the composite sheet against the covering after the steps of providing to bond the covering to the composite sheet. The method further includes injecting a molten polymer compatible with the polymeric material of the composite sheet into the mold cavity in accordance with a predetermined set of process parameters which are high enough to integrally form at least one structural component via polymeric interfusion at the inner surface of the composite sheet but low enough to avoid damaging the covering.

This method may be entitled:

Compression Molding & Injection Molding Hybrid with In Mold Cover Stock

The following bullet points are applicable to this method:
Similar to the methods described with reference to FIGS. 1-8 but instead of skin/foam a different cover stock is utilized (i.e. a decorative fibrous fabric such as a carpet)
The ability to maintain lower internal molding pressures to not damage carpet while allowing for the typical higher molding pressures of injection molding is important to this technology
   The inventors have done this by modifying Moldflow simulation software by Autodesk, to recognize the lower internal molding pressure requirement.
      Example—Lower pack pressure by 15-20%
      Example—Lower injection pressure by 15-20%
      Example—Lower material injection temperature by 10-15%
      Example—Add delay in injection time to allow compression process to cure
      Both of these increase the need for drops which lowers the overall required close tonnage which also helps with reducing pressure on the cover stock to improve surface quality.
   The pressure parameters have been developed through actual trials on a prototype tool (this was needed to eliminate or reduce read through from the injection molded details)
   Different carpets or fabrics will have different pressure requirements
   After the Moldflow was completed the inventors saw a higher number of injection drop locations needed to maintain the lower pressure
   The inventors also pre-compress the compression molding material to the tool thickness to help reduce the internal molding pressure
   There is also a time delay from the time the part compresses to when the injection portion of the process starts. The inventors increased this delay to reduce material heat to help eliminate sink through the cover stock material.

The lower pressures and temperatures are lower than what one would run for injection+compression without in-mold carpet. For example, on automotive door uppers the inventors ran 1200 gsm NFPP+GFPP injection details without a coverstock where the average injection pressures are around 1000 psi. The inventors ran at 1000 psi, because the inventors were not worried about rib bleed through affecting carpet on the A-side of the part. The inventors would run the same part at around 800 psi assuming one had inmold carpet to insure the inventors did not get the plastic bleed through on the A-side carpet. The Moldflow shows one should run closer to 1500 psi but due to the inventors expertise, the inventors knew the pressure was much lower. Consequently, the inventors modified the parameters of the Moldflow program in an unexpected fashion. Also, this pressure directly affect the amount of gates needed to fill the part (the more pressure the more surface one can fill).

A second method may be characterized as a compression and injection hybrid process or compression molding process with in mold cover stock that allows for post mold edge folding of cover stock for edge quality improvements.

An objective of this method is to combine compression molding, injection molding, and cover stock forming lamination into a two-step process which allows the cover stock to be separated from main part substrate at the edge of the substrate to allow for post mold or in-mold trimming of the different materials to allow edge folding of the cover stock.

Generally, this is a method of making a trim component having an edge-wrapped, fibrous decorative covering. The method includes providing a polymeric composite sheet having inner and outer surfaces, providing a fibrous decorative covering overlying the outer surface of the composite sheet and pressing in a mold cavity at a molding station, the composite sheet against an interior portion of the covering after the steps of providing to bond the interior portion of the covering to the composite sheet while maintaining at least one exterior edge portion of the covering unbonded to the composite sheet. The method also includes injecting a molten polymer compatible with the polymeric material of the composite sheet into the mold cavity in accordance with a predetermined set of process parameters which are high enough to integrally form at least one structural component via polymeric interfusion at the inner surface of the composite sheet but low enough to avoid damaging the covering. The method also includes folding the at least one unbonded, exterior edge portion of the covering over the composite sheet to form the trim component.

The following bullet points are applicable to this method:
Similar to the methods described with reference to FIGS. 1-8 but skin/foam is replaced with a fibrous decorative covering such as fabric or carpet.
All the same bullet points apply for this technology as the points listed under the first method.
Separating the cover stock from the compression molded material at the trim/wrap edge is important to this technology.
   This separation is done through the molding tool design
   A lifter or moveable tool details covers the cover stock to create a new tool surface that allows for the material separation. A typical lifter is shown in FIG. 28.

A third method may be characterized as:

Compression Molding & Injection Molding Hybrid for Airbag System with in Mold Cover Stock

Generally, this is a method of making a vehicle interior component having an integral airbag component and a fibrous decorative covering. The method includes providing a polymeric composite sheet and a fibrous decorative covering overlying an outer surface of the composite sheet. The composite sheet is pressed against the covering after the steps of providing to bond the covering to the composite sheet. A molten polymer compatible with the polymeric material of the composite sheet is injected into a mold cavity in accordance with a predetermined set of process parameters which are high enough to integrally form at least one airbag component via polymeric interfusion at the inner surface of the composite sheet but low enough to avoid damaging the covering.

In each of these three methods, preferably, the process parameters include material packing pressure, material injection pressure and material injection temperature.

The process parameters may include a time delay between the step of pressing and the step of injecting.

Preferably, the decorative covering is a woven or non-woven fabric such as carpet. The carpet may have an upper thermoplastic fiber layer and a lower thermoplastic backing layer as disclosed in U.S. patent publication 2013/0333837. The preferred thermoplastic is PET, PP or nylon typically. The fibers are typically non-woven but tufted carpets may be used. Such carpets could be considered woven or needled.

The at least one structural component may include an attachment component such as a “dog house.”

The polymeric material of the sheet may be a thermoplastic such as polypropylene.

Also, preferably, the method further includes compressing the composite sheet to a desired thickness prior to the step of pressing.

Other types of fabric other than carpet could be used. Textiles such as typical headliner fabric (i.e. foam/scrim) could be used. If not applied “in mold” (i.e. “out-mold”), coverstocks such as carpets, textiles, leather, wood, films, or bi-laminates could be used.

A forth method may be characterized as a compression and injection hybrid process for an airbag system.

An objective of the method is to combine compression molding and injection molding to create geometry necessary to house and cover an airbag module.

Generally, this is a method of making a vehicle interior component having an integral airbag component. The method includes disposing a polymeric composite sheet having inner and outer surfaces onto a first surface of a mold at a molding station and compressing the sheet between the first surface and a second surface of the mold at the molding station. The method also includes injecting a molten polymer compatible with the polymeric material of the composite sheet into the mold cavity in accordance with a predetermined set of process parameters which are high enough to integrally form at least one airbag component via polymeric interfusion at the inner surface of the composite sheet but low enough to reduce surface defects on the outer surface of the composite sheet.

The process parameters may include material packing pressure and material injection pressure.

The process parameters may include material injection temperatures and a time delay between the step of compressing and the step of injecting. The interior component may be a panel such as an instrument panel of FIGS. 29 and 30. The at least one airbag component may include an airbag deployment chute as indicated in FIG. 30. The surface defects may include part sink or read-through.

The polymeric material of the sheet may be a thermoplastic such as polypropylene.

This method may be entitled:

Compression Molding & Injection Molding Hybrid for Airbag System

The following bullet points are applicable to this method:
Similar to the methods described with reference to FIGS. 1-8 but the inventors mold a functional airbag component in place of ribs or attachments.
Others have insert molded an airbag chute, but not a direct injected airbag chute as described herein.
This reduces cost and opens up design flexibility
The inventors have also developed a way to allow for the tear seem to be molded in the compression molding cycle through a A-surface piece (similar to a stitch pattern).

Referring now specifically to FIGS. 9-30, FIG. 9 is a schematic perspective view of an “A” side 108 of a hybrid injection-compression molded upper interior vehicle door panel, generally indicated at 110, with its laminated outer facing carpeting or fabric 112 wherein openings 114 for hardware still need to be trimmed out.

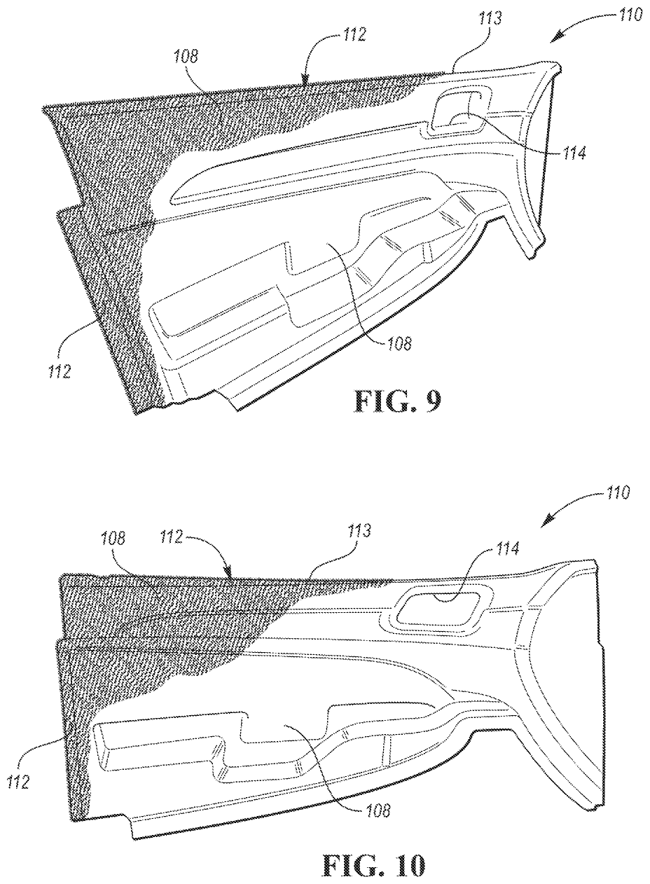

FIG. 10 is a schematic perspective view similar to the view of FIG. 9 but at a slightly different angle.

FIG. 11 is a schematic perspective view of a “B’ side 109 of the panel 110 of FIGS. 9 and 10 illustrating a plurality of injection molded components 116 formed on a compression molded composite sheet 140. The components 116 typically are attachment and rib components which are interconnected via plastic runners 118 also formed on the composite sheet 140. The components 116 typically include ribs, posts and receptacles all of which are injection molded.

FIG. 12 is a view similar to the view of 11 but at a slightly different angle.

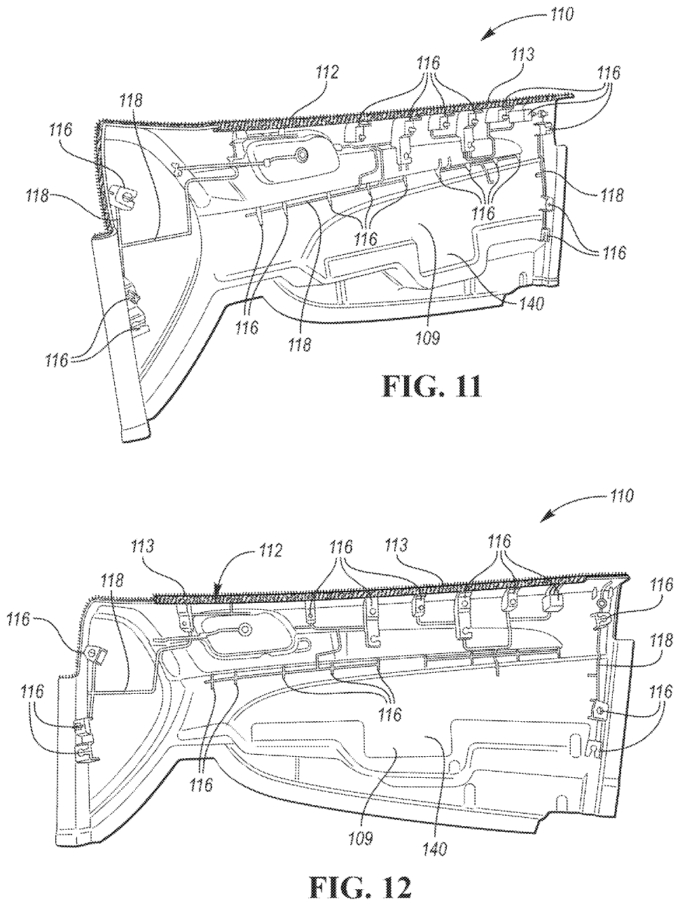

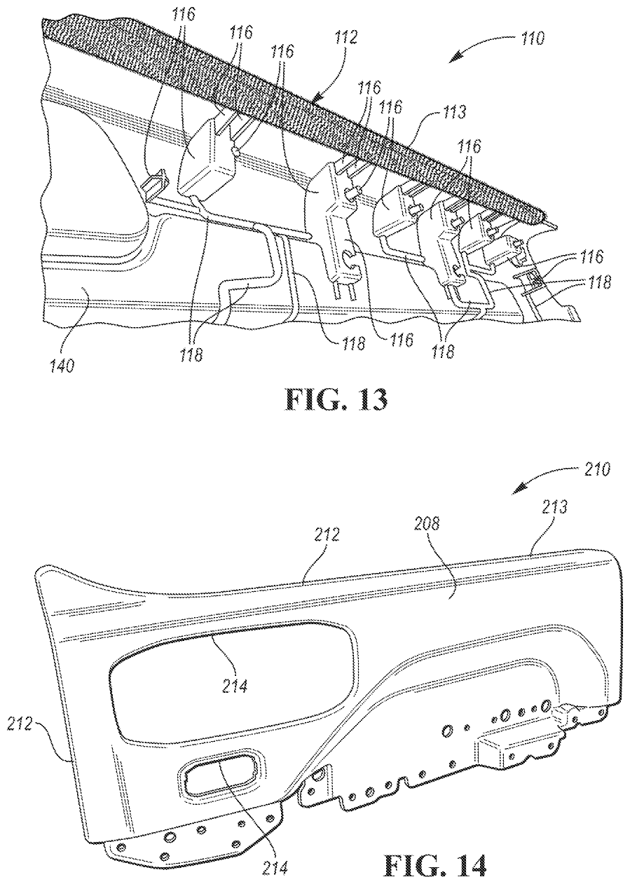

FIG. 13 is an enlarged schematic perspective view, partially broken away, of the “B” side 109 of the panel 110 of FIGS. 9-12.

FIGS. 14-18 disclose a door upper panel, generally indicated at 210, constructed in accordance with another embodiment wherein FIG. 14 is a schematic perspective view of the “A” side 208 of the panel 210. The panel 210 includes apertures 214 and edges 213 of a folded coverstock 212.

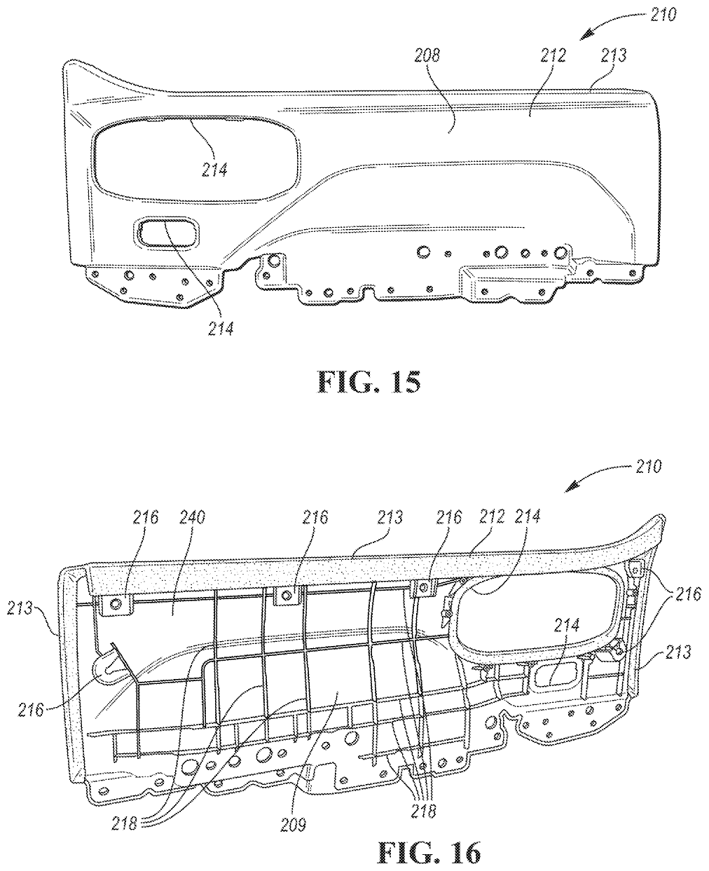

FIG. 15 is a schematic perspective view similar to the view of FIG. 14 but at a slightly different angle.

FIG. 16 is a schematic perspective view of a “B” side 209 of the panel 210 of FIGS. 14 and 15 illustrating a plurality of injection molded components 216 and runners 218 molded on a surface of a compression molded composite sheet 240.

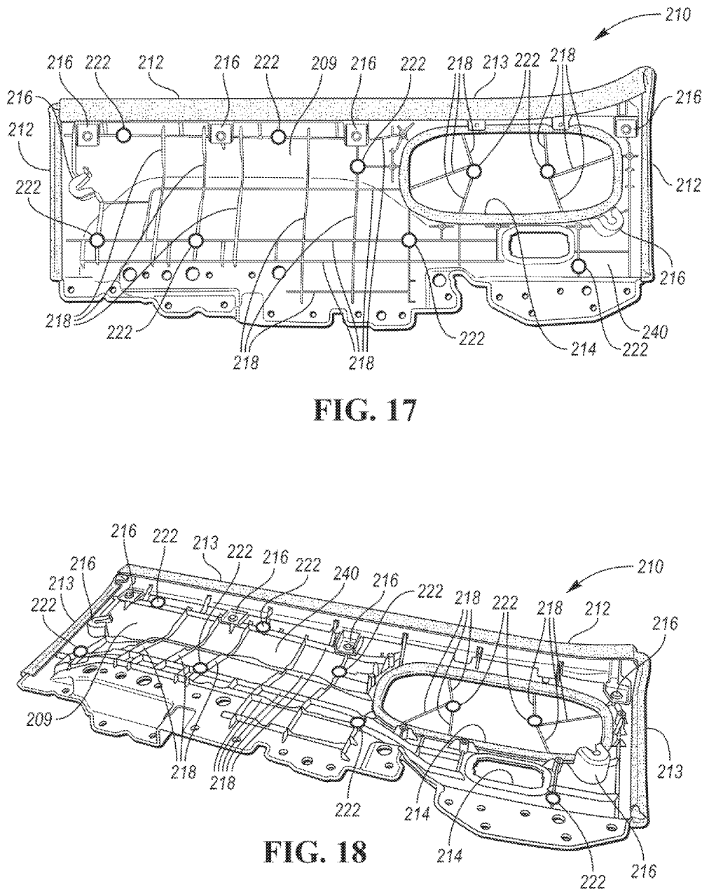

FIGS. 17 and 18 are views similar to the view of FIG. 16 but at slightly different angles and illustrating molten plastic drops 222 for forming the injection molded components 216 and runners 218.

FIG. 19 is a side elevational view of an “A” side 308 of a panel, generally indicated at 310, constructed in accordance with yet another embodiment of the invention.

FIG. 20 is an enlarged, schematic perspective view, partially broken away, of the “B” side 309 of the panel 310 of FIG. 19.

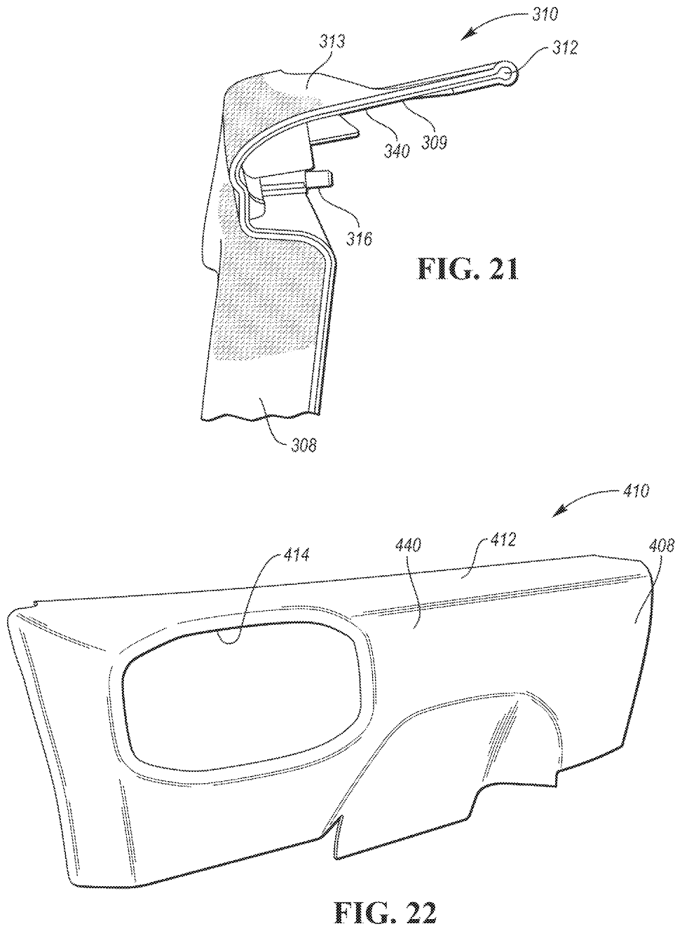

FIG. 21 is an end view, partially broken away, of the panel 310 of FIGS. 19 and 20 with the carpet or fabric layer 312 folded or wrapped around an edge 313 the compression molded composite sheet 340.

FIG. 22 is a schematic perspective view of the “A” side 408 of a compression molded composite sheet 440 of yet another embodiment of a panel, generally indicated at 410.

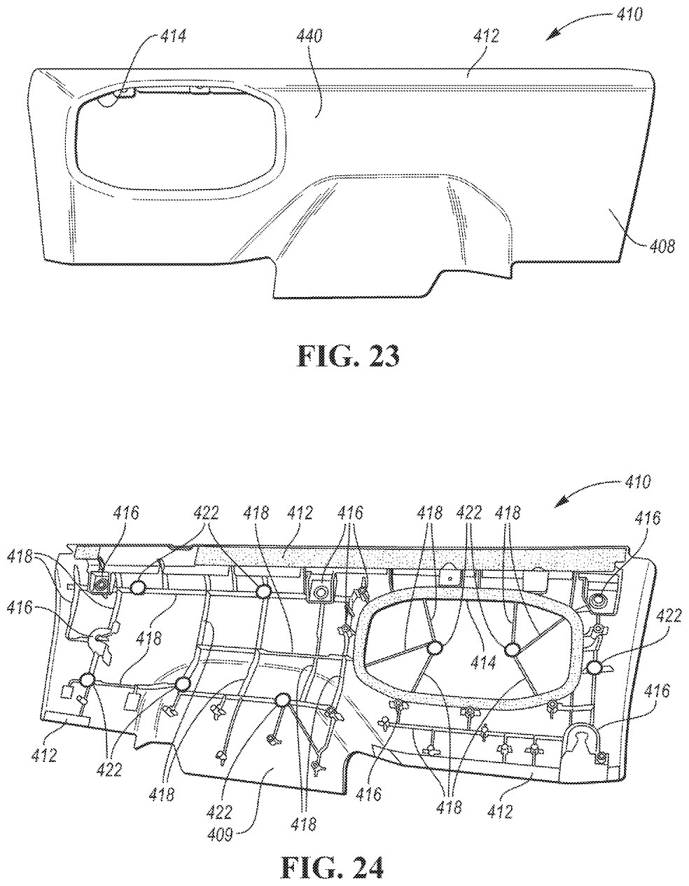

FIG. 23 is a view similar to the view of FIG. 22 but at a slightly different angle.

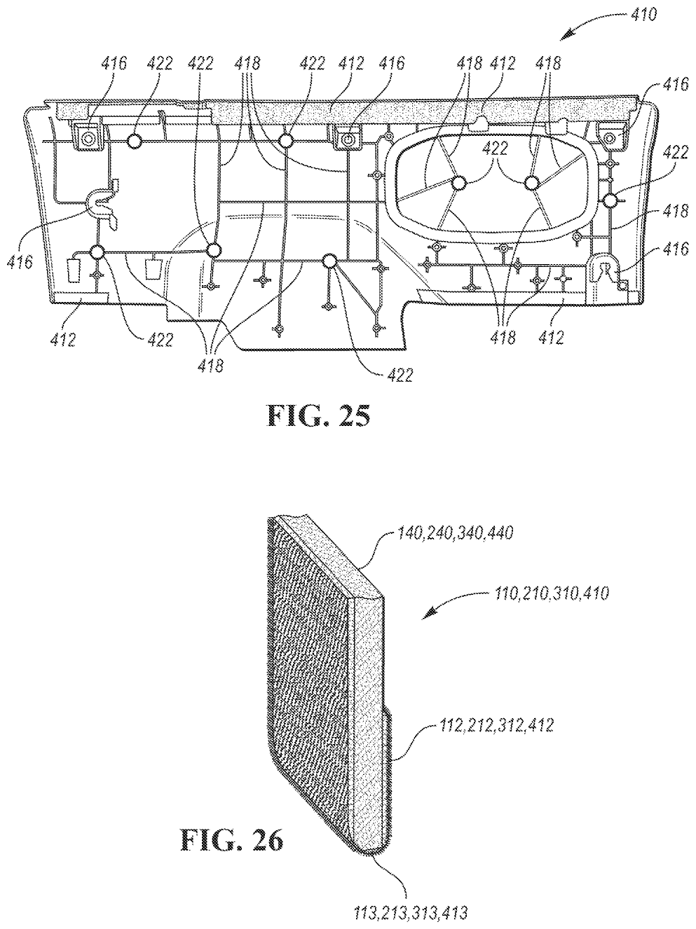

FIGS. 24 and 25 are schematic perspective views of a “B” side 409 of the panel 410 of FIG. 23 and illustrating a plurality of plastic drops 422 for forming the injection molded components 416 and runners 418 on the “B” side 409.

FIG. 26 is a view, partially broken away and in cross section, of one of the panels 110, 210, 310 or 410 of FIGS. 9-25 with its carpet or fabric layer 112, 212, 312 or 412 folded over its compression molded composite sheet 140, 240, 340 or 440.

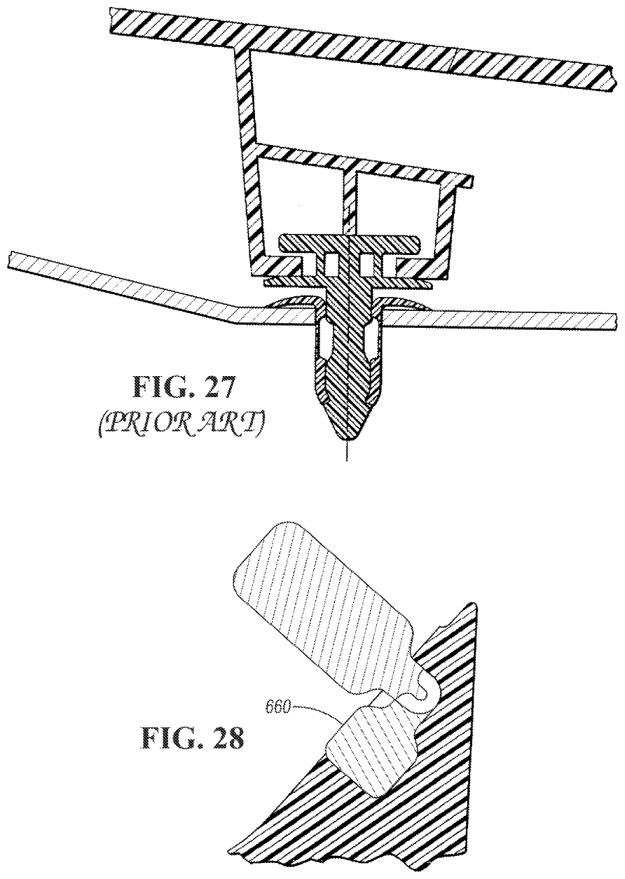

FIG. 27 is a view, partially broken away and in cross section of a prior art automotive trim panel assembly disclosed in U.S. Pat. No. 6,196,607.

FIG. 28 is a sectional view illustrating movable tooling such as a lifter 660 to cover coverstock material 112, 212, 312 or 412 to create a new tool surface which allows for coverstock separation from the molded composite sheet 140, 240, 340 or 440 for folding purposes. The lifter 660 is similar to a lifter 60 shown in FIG. 5 of U.S. Pat. No. 6,196,607.

FIG. 29 is a schematic perspective view of the “A” side 708 of an air bag deployment panel, generally indicated at 710, which has been formed via compression and injection molding in accordance with at least one embodiment of the present invention to include an inspection molded airbag deployment chute, generally indicated at 712, on its “B” side 709.

FIG. 30 is a cross sectional view of the air bag deployment panel 710 of FIG. 29 illustrating the airbag chute 712 formed by injection molding on the “B” side 709 of the compression molded composite sheet 740 and an airbag 733 illustrated by phantom lines.

In particular, FIG. 29 illustrates an air bag deployment panel assembly 710 comprising an air bag deployment chute 712 (in hidden lines) and panel member 714 in accordance with the present invention. The air bag deployment chute 712 cooperates with panel member 714 for deploying an air bag through the panel member 714 into a compartment of a vehicle. As shown, the panel member 714 may comprise a vehicle's front panel member to which the deployment chute 712 is disposed for deploying the air bag 733 to dissipate impact energy upon an outer show or “A” surface 716 during an impact of the vehicle. FIG. 29 depicts one embodiment of the present invention, wherein the deployment chute 712 is located adjacent a front passenger's seat. Of course, the deployment chute 712 may be positioned against a front panel member and located adjacent a driver's seat of a vehicle, on a side panel member, or any other suitable panel member.

As shown in FIG. 29, the panel member 714 has the outer show or “A” surface 716 and an inner “B” surface 718. The deployment chute 712 is attached to the inner surface 718 of the panel member 714. As will be described in greater detail below, the deployment chute 712 is integrally molded onto the inner surface 718. The panel member 714 includes a groove 720 formed on inner surface 718. The groove 720 forms a structurally weakened area 721 of the panel member 714 to enable selective air bag deployment through the structurally weakened area.

As shown in FIG. 30, the deployment chute 712 comprises a stationary portion 722 and a door portion 742. The stationary portion 722 includes a base 723 and a peripheral wall 724 which is integrally connected to base 723. As shown, the base 723 includes first and second surfaces 726, 728.

The base 723 further an has inner periphery 732 to define an opening 730. The peripheral wall 724 is integrally connected to a second surface 728 of the base 723 and extends therefrom adjacent the inner periphery 732. The peripheral wall 724 defines a channel 734 through which the air bag 733 may be deployed during a vehicle impact to dissipate impact energy onto the outer show surface 716. The stationary portion 722 is configured to receive the air bag 733 within the channel 734 to guide the air bag 733 through the stationary portion 722 during deployment of the air bag 733. The channel 734 provides energy used in deployment of the air bag 733 to be concentrated about the opening 730. This allows the door portion 742 to more efficiently and adequately pivot away from the deployment chute 712 and through the panel member 714. The peripheral wall 724 includes a plurality of gussets 736 which are integrally connected to the second surface 728 of the base 723. The gussets 736 are configured to provide support to the peripheral wall 724 during deployment of the air bag 733 through the opening 730.

As shown in FIG. 30, the door portion 742 is positioned against the inner surface 718 of the panel member 714 and within the opening 730 adjacent the air bag 733. As shown, the door portion 742 is circumscribed by the stationary portion 722 through which the air bag 733 is deployed upon vehicle impact. In this embodiment, the door portion 742 is integrally connected in part to the base 723 to hinge the door portion 742 to the stationary portion 722. This facilitates pivotal movement of the door portion 742 to allow deployment of the air bag 733 through the opening 730 of the stationary portion 722 and through the structurally weakened area of the panel member 714 during impact of the vehicle. Of course, the door portion 742 may be connected to the base 723 in any other suitable way to hinge the door portion 742 to the stationary portion 722, allowing pivotal movement of the door portion 742 during deployment of the air bag 733. However, in this embodiment, the door portion 742 is integrally molded with the base 723.

As depicted in FIG. 30, the groove 720 is formed on the inner surface 718 of the panel member 714 without any substantial visibility on the outer surface 716. As shown in FIG. 30, the groove 720 is formed on the first surface 726 of the base 723 and adjacent the stationary portion 722.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of making a vehicle interior component having an integral airbag component, the method comprising:
disposing a polymeric composite sheet having inner and outer surfaces onto a first surface of a mold at a molding station;
compressing the sheet between the first surface and a second surface of the mold at a molding station; and
injecting a molten polymer compatible with the polymeric material of the composite sheet into the mold cavity in accordance with a predetermined set of process parameters which are high enough to integrally form at least one airbag component via polymeric interfusion at the inner surface of the composite sheet but are low enough to reduce surface defects on the outer surface of the composite sheet.

2. The method as claimed in claim 1 wherein the process parameters include material packing pressure.

3. The method as claimed in claim 1 wherein the process parameters include material injection pressure.

4. The method as claimed in claim 1 wherein the process parameters include material injection temperature.

5. The method as claimed in claim 1 wherein the process parameters include a time delay between the step of compressing and the step of injecting.

6. The method as claimed in claim 1 wherein the interior component is a panel.

7. The method as claimed in claim 6 wherein the panel is an instrument panel.

8. The method as claimed in claim 1 wherein the at least one airbag component includes an airbag deployment chute.

9. The method as claimed in claim 1 wherein the surface defects include part sink or read-through.

10. The method as claimed in claim 1 wherein the polymeric material of the sheet is a thermoplastic.

11. A method of making a vehicle trim component having an integral airbag component, the method comprising:
disposing a polymeric composite sheet having inner and outer surfaces onto a first surface of a mold at a molding station;
compressing the sheet between the first surface and a second surface of the mold at a molding station; and
injecting a molten polymer compatible with the polymeric material of the composite sheet into the mold cavity in accordance with a predetermined set of process parameters which are high enough to integrally form at least one airbag component via polymeric interfusion at the inner surface of the composite sheet but are low enough to reduce surface defects on the outer surface of the composite sheet.

12. The method as claimed in claim 11 wherein the process parameters include material packing pressure.

13. The method as claimed in claim 11 wherein the process parameters include material injection pressure.

14. The method as claimed in claim 11 wherein the process parameters include material injection temperature.

15. The method as claimed in claim 11 wherein the process parameters include a time delay between the step of compressing and the step of injecting.

16. The method as claimed in claim 11 wherein the interior component is a panel.

17. The method as claimed in claim 16 wherein the panel is an instrument panel.

18. The method as claimed in claim 11 wherein the at least one airbag component includes an airbag deployment chute.

19. The method as claimed in claim 11 wherein the surface defects include part sink or read-through.

20. The method as claimed in claim 11 wherein the polymeric material of the sheet is a thermoplastic.

21. A method of making a vehicle interior trim component having an integral airbag component, the method comprising:
disposing a polymeric composite sheet having inner and outer surfaces onto a first surface of a mold at a molding station;
compressing the sheet between the first surface and a second surface of the mold at the molding station; and
injecting a molten polymer compatible with the polymeric material of the composite sheet into the mold cavity in accordance with a predetermined set of process parameters which are high enough to integrally form at least one airbag component via polymeric interfusion at the inner surface of the composite sheet but are low enough to reduce surface defects on the outer surface of the composite sheet.

22. The method as claimed in claim 21 wherein the process parameters include material packing pressure.

23. The method as claimed in claim 21 wherein the process parameters include material injection pressure.

24. The method as claimed in claim 21 wherein the process parameters include material injection temperature.

25. The method as claimed in claim 21 wherein the process parameters include a time delay between the step of compressing and the step of injecting.

26. The method as claimed in claim 21 wherein the interior component is a panel.

27. The method as claimed in claim 26 wherein the panel is an instrument panel.

28. The method as claimed in claim 21 wherein the at least one airbag component includes an airbag deployment chute.

29. The method as claimed in claim 21 wherein the surface defects include part sink or read-through.

30. The method as claimed in claim 21 wherein the polymeric material of the sheet is a thermoplastic.
